(19) United States
(12) Patent Application Publication
(10) Pub. No.: US 2021/0357907 A1
(43) Pub. Date: Nov. 18, 2021

(54) SYSTEM, APPARATUS, AND/OR METHOD FOR PROVIDING WIRELESS APPLICATIONS BASED ON LOCATIONING SOLUTIONS

(71) Applicant: Deeyook Location Technologies Ltd., Tel Aviv (IL)

(72) Inventors: Eran SHPAK, Tel Aviv (IL); Richard N. NOTTENBURG, New York, NY (US)

(21) Appl. No.: 15/930,043

(22) Filed: May 12, 2020

(51) Int. Cl. G06Q 20/32; G06Q 20/40; G06Q 20/20; G06Q 20/34; H04W 12/06; H04W 4/029

(52) U.S. Cl. CPC G06Q 20/3278; G06Q 20/40; H04W 4/029; G06Q 20/341; H04W 12/06; G06Q 20/20

(57) ABSTRACT

In at least one embodiment, a system for enabling an electronic transaction for a purchase based on wireless communication is provided. The system includes at least one transceiver and an electronic authentication card. The electronic authentication card includes the at least one transceiver to initiate a purchase for a user. The electronic authentication card is programmed to wirelessly receive a plurality of wireless signals from at least one transmitter and process the plurality of wireless signals to generate first information indicative of a location of the electronic authentication card. The electronic authentication card is further programmed to wirelessly transmit the first information to a server and to wirelessly receive location coordinates from the server identifying the location of the electronic authentication card based on the first information.

### TECHNICAL FIELD

Aspects disclosed herein generally relate to system, apparatus, and method for providing wireless applications based on locationing solutions. Specifically, embodiments disclosed herein provide locationing solutions for mobile devices (e.g., wireless transmitters and/or receivers) that include, but not limited to, carrier phase difference (CPD), Multiple-Input-Multiple Output (MIMO) orthogonal frequency domain multiplexing (OFDM) transmissions, WiFi access points, and base stations. Such locationing aspects may be extended to various wireless applications that include, but not limited to, mobile device payments, mobile chain of custody, ride share rendezvous, and mobile parcel management. These aspects and others will be discussed in more detail herein.

### BACKGROUND

U.S. Pat. No. 10,182,315 to Shpak (hereafter the '315 patent) discloses a method for signal processing that includes receiving at a given location, at least first and second signals transmitted, respectively, from at least first and second antennas of a wireless transmitter. The at least first and second signals encode identical data using a multi-carrier encoding scheme with a predefined cyclic delay between the transmitted signals. The received first and second signals are processed, using the cyclic delay, in order to derive a measure of a phase delay between the first and second signals. Based on the measure of the phase delay, an angle of departure of the first and second signals from the wireless access point to the given location is estimated.

U.S. Pat. No. 9,814,051 also to Shpak (hereafter the '051 patent) discloses a method for signal processing. The method provides, among other things, receiving at a given location at least first and second signals transmitted, respectively, from at least first and second antennas of a wireless transmitter, the at least first and second signals encoding identical data using a multi-carrier encoding scheme with a predefined cyclic delay between the transmitted signals and processing the received first and second signals, using the cyclic delay, in order to derive a measure of a phase delay between the first and second signals. Based on the measure of the phase delay, the method provides estimating an angle of departure of the first and second signals from the wireless transmitter to the given location.

### SUMMARY

In at least one embodiment, a system for enabling an electronic transaction for a purchase based on wireless communication is provided. The system includes at least one transceiver and an electronic authentication card. The electronic authentication card includes the at least one transceiver to initiate a purchase for a user. The electronic authentication card is programmed to wirelessly receive a plurality of wireless signals from at least one transmitter and process the plurality of wireless signals to generate first information indicative of a location of the electronic authentication card. The electronic authentication card is further programmed to wirelessly transmit the first information to a server and to wirelessly receive location coordinates from the server identifying the location of the electronic authentication card based on the first information.

In at least one embodiment, a method for enabling an electronic transaction for a purchase based on wireless communication is provided. The method includes receiving a plurality of wireless signals, via at least one transceiver, from at least one transmitter and processing the plurality of wireless signals to generate first information indicative of a location of the electronic authentication card. The method further includes wirelessly transmitting the first information to a server and wirelessly receiving location coordinates from the server identifying the location of the electronic authentication card based on the first information.

In at least one embodiment, a computer-program product embodied in a non-transitory computer read-able medium that is programmed for enabling an electronic transaction for a purchase based on wireless communication is provided. The computer-program product includes instructions for receiving a plurality of wireless signals, via at least one transceiver, from at least one transmitter and processing the plurality of wireless signals to generate first information indicative of a location of the electronic authentication card. The computer-program product further includes instructions for wirelessly transmitting the first information to a server and wirelessly receiving location coordinates from the server identifying the location of the electronic authentication card based on the first information.

In at least one embodiment, a system for performing chain of custody monitoring is provided. The system includes at least one transceiver and at least one processor. The at least one transceiver receives a plurality of wireless signals from at least one transmitter. The at least one processor is coupled to the at least one transceiver and to an object. The at least one processor is programmed to process the plurality of wireless signals to generate first information indicative of a plurality of locations of the object and to wirelessly transmit the first information to a server. The at least processor is further programmed to wirelessly receive a plurality of location coordinates from the server identifying the plurality of locations of the object based on the first information as the object travels from a starting point to an arrival point.

In at least one embodiment, a method for performing chain of custody monitoring is provided. The method includes receiving a plurality of wireless signals from at least one transmitter and attaching at least one processor and at least one transceiver to an object. The method further includes processing the plurality of wireless signals to generate first information indicative of a plurality of locations of the object and wirelessly transmitting the first information to a server. The method further includes wirelessly receiving a plurality of location coordinates from the server identifying the plurality of locations of the object based on the first information as the object travels from a starting point to an arrival point.

In at least one embodiment, a computer-program product embodied in a non-transitory computer read-able medium that is programmed for performing chain of custody monitoring is provided. The computer-program product includes instructions for receiving, at at least one transceiver, a plurality of wireless signals from at least one transmitter. The at least one processor and the at least one transceiver are attached to an object. The computer-program product includes instructions for processing the plurality of wireless signals to generate first information indicative of a plurality of locations of the object and for wirelessly transmitting the first information to a server. The computer-program product further includes instructions for wirelessly receiving a plurality of location coordinates from the server identifying the plurality of locations of the object based on the first information as the object travels from a starting point to an arrival point.

In at least one embodiment, a system for monitoring a transit of a parcel is provided. The system includes at least one transceiver and at least one processor. The at least one transceiver is programmed to receive a plurality of wireless signals from at least one transmitter. The at least one processor is coupled to the at least one transceiver and to the parcel. The at least one processor is programmed to process the plurality of wireless signals to generate first information indicative of a plurality of locations of the parcel and to transmit the first information to a server. The at least one processor is further programmed to receive a plurality of location coordinates from the server identifying the plurality of locations of the parcel based on the first information as the parcel travels from a starting point to an arrival point.

In at least one embodiment, a method for monitoring a transit of a parcel is provided. The method includes receiving, at at least one transceiver, a plurality of wireless signals from at least one transmitter. The at least one processor is coupled to the at least one transceiver and to the parcel. The method further includes processing the plurality of wireless signals to generate first information indicative of a plurality of locations of the parcel and to transmit the first information to a server and receiving a plurality of location coordinates from the server identifying the plurality of locations of the parcel based on the first information as the parcel travels from a starting point to an arrival point.

In at least one embodiment, a computer-program product embodied in a non-transitory computer read-able medium that is programmed for monitoring a transit of a parcel is provided. The computer-program product includes instructions for receiving, at at least one transceiver, a plurality of wireless signals from at least one transmitter. The at least one processor is coupled to the at least one transceiver and to the parcel. The computer-program product includes instructions for processing the plurality of wireless signals to generate first information indicative of a plurality of locations of the parcel and for transmitting the first information to a server. The computer-program product includes instructions for receiving a plurality of location coordinates from the server identifying the plurality of locations of the parcel based on the first information as the parcel travels from a starting point to an arrival point.

In at least one embodiment, a shipping container is provided. The shipping container includes a parcel, an array of antennas, and a location tag. The parcel is configured to store a good. The array of antennas wirelessly receives a plurality of wireless signals. The location tag includes the array of antennas for attachment to the parcel. The location tag is programmed to process the plurality of wireless signals to generate first information indicative of a plurality of locations of the parcel during transit and transmit the first information to a server. The location tag is further programmed to receive a plurality of location coordinates from the server identifying the plurality of locations of the parcel based on the first information as the parcel travels from a starting point to a destination point.

In at least one embodiment a method for providing a shipping container is provided. The method includes storing a good in a parcel and wirelessly receiving, via an array of antennas of a location tag, a plurality of wireless signals. The method further includes processing the plurality of wireless signals to generate first information indicative of a plurality of locations of the parcel during transit and transmitting the first information to a server. The method further includes receiving a plurality of location coordinates from the server identifying the plurality of locations of the parcel based on the first information as the parcel travels from a starting point to a destination point.

In at least one embodiment, a system for providing a location of a vehicle to a user is provided. The system includes at least one transceiver and at least one processor. The at least one transceiver is programmed to receive a plurality of wireless signals from at least one transmitter. The at least one processor is coupled to the at least one transceiver and to the vehicle. The at least one processor is programmed to process the plurality of wireless signals to generate first information indicative of a location of the vehicle and transmit the first information to a server. The at least one processor is further programmed to receive location coordinates from the server identifying the location of the vehicle.

In at least one embodiment, a method for providing a location of a vehicle to a user is provided. The method includes receiving, at at least one transceiver, a plurality of wireless signals from at least one transmitter. An at least one processor is coupled to the at least one transceiver and to the vehicle. The method further includes processing the plurality of wireless signals to generate first information indicative of a location of the vehicle and transmitting the first information to a server. The method further includes receive location coordinates from the server identifying the location of the vehicle.

In at least one embodiment, a computer-program product embodied in a non-transitory computer read-able medium that is programmed for providing a location of a vehicle to a user is provided. The computer-program product includes instructions for receiving, at at least one transceiver, a plurality of wireless signals from at least one transmitter. An at least one processor is coupled to the at least one transceiver and to the vehicle. The computer-program product includes instructions for processing the plurality of wireless signals to generate first information indicative of a location of the vehicle and for transmitting the first information to a server. The method further includes instructions for receiving location coordinates from the server identifying the location of the vehicle.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompany drawings in which:

FIG. 1 is schematic, pictorial illustration of a system for wireless location finding, in accordance with an embodiment;

FIG. 2 is a diagram that schematically illustrates a coordinate frame used in deriving an angle of departure or arrival of wireless signals from a transmitter to a receiver, in accordance with an embodiment;

FIG. 3A is a schematic, pictorial illustration of components of the system of FIG. 1 that illustrates a method for finding the location of a mobile communication device, in accordance with an embodiment;

FIG. 3B is a diagram that schematically illustrates a method for finding the location of a mobile communication device in accordance with an embodiment;

FIG. 4 is a diagram that schematically illustrates a process of location finding based on multiple transmitters in accordance with an embodiment;

FIG. 5 depicts a method for location finding in accordance with an embodiment;

FIG. 6 depicts an example of a wireless communication system in accordance to one embodiment;

FIG. 7 depicts an apparatus that may be implemented in the wireless communication system of FIG. 6 in accordance to one embodiment;

FIG. 8 generally depicts a first system for determining the location of any one of the mobile devices relative to the access points in accordance to one embodiment;

FIG. 9 generally depicts a location of the receiver in relation to a plurality of hyperbolas in accordance to one embodiment;

FIG. 10 depicts a method for determining a location of the receiver in accordance to one embodiment;

FIG. 11 depicts a second system for determining the location of any one of the transmitters relative to the mobile devices in accordance to one embodiment;

FIG. 12 illustrates a two-antenna implementation on a given transmitter with the cyclic delay diversity;

FIG. 13 illustrates a single antenna implementation on a given transmitter;

FIG. 14 depicts at least one aspect related to performing a coarse detection and a fine detection method in accordance to one embodiment;

FIGS. 15 and 16 illustrate two arbitrary scenarios for time of flight (TOF) values and Direction of Departure (DoD) angles associated with a precise time detection scheme in accordance to one embodiment;

FIG. 17 depicts a method for performing interpolation to perform a fine determination of the of time of arrival of signals received at one or more of the receivers in accordance to one embodiment;

FIG. 18 generally illustrates a system that provides locationing information for a commercial transaction (e.g., mobile payment) in accordance to one embodiment;

FIG. 19 depicts a method for determining a location of the electronic authentication card through the utilization of the Time of Flight methodology in accordance to one embodiment;

FIG. 20 depicts a first method for corroborating a purchase via the electronic authentication card in accordance to one embodiment;

FIG. 21 depicts a second method for corroborating a purchase via the electronic authentication card in accordance to one embodiment;

FIG. 22 depicts a third method for corroborating a purchase via the electronic authentication card in accordance to one embodiment;

FIG. 23 depicts a fourth method for corroborating a purchase via the electronic authentication card in accordance to one embodiment;

FIG. 24 depicts a system for monitoring an object based on locationing information to perform chain of custody examination in accordance to one embodiment;

FIG. 25 depicts a method for monitoring an object based on locationing information to perform chain of custody examination in accordance to one embodiment;

FIG. 26 depicts a system for directing a vehicle to a user based on locationing information in accordance to one embodiment; and

FIG. 27 depicts a method for directing a vehicle to the user based on locationing information in accordance to one embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It is recognized that at least one controller (or at least one processor) as disclosed herein may include various microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, the at least one controller as disclosed herein utilize one or more microprocessors to execute a computer-program that is embodied in a non-transitory computer readable medium that is programmed to perform any number of the functions as disclosed. Further, the controller(s) as provided herein includes a housing and the various number of microprocessors, integrated circuits, and memory devices ((e.g., FLASH, random access memory (RAM), read only memory (ROM), electrically programmable read only memory (EPROM), electrically erasable programmable read only memory (EEPROM)) positioned within the housing. The disclosed controller(s) also include hardware-based inputs and outputs for receiving and transmitting data, respectively from and to other hardware-based devices as discussed herein.

Aspects disclosed herein generally provide locationing solutions for mobile devices (e.g., wireless transmitters and/or receivers). Such locationing solutions may be based, but not limited to, carrier phase difference (CPD), Multiple-Input-Multiple Output (MIMO) orthogonal frequency domain multiplexing (OFDM) transmissions, WiFi access points, and base stations. These locationing aspects may be extended to various wireless applications that include, but not limited to, mobile device payments, mobile chain of custody, mobile parcel management, etc. These aspects and others will be discussed in more detail herein.

In terms of finding the location of a mobile wireless transceiver, such as a mobile device, the utilization of Global Positioning System (GPS) generally derives location coordinates from signals transmitted by geostationary satellites. Because of its dependence on weak satellite signals, however, GPS works poorly, if at all, in indoors and in crowded urban environment (e.g., with crowded buildings). Cellular networks are also capable of triangulating (or trilaterating) telephone location based on signals received or transmitted between the cellular telephone and multiple cellular antennas, but this technique is inaccurate and unreliable. Aspects disclosed herein provide locationing solutions that operate outside of GPS based implementations. For example, the locationing schemes as disclosed herein may correspond to schemes as set forth in pending U.S. application Ser. No. 16/731,106 (“the '106 application”) entitled “INTERFEROMETRIC LOCATION SENSING” as filed on Dec. 31, 2019 and in pending U.S. application Ser. No. 16/814,356 (“the '356 application”) entitled “SYSTEM, APPARATUS, AND/OR METHOD FOR DETERMINING A TIME OF FLIGHT FOR ONE OR MORE RECEIVERS AND TRANSMITTERS” as filed on Mar. 10, 2020 the disclosures of which are hereby incorporated by reference in their entirety. It is further recognized that any one or more of the devices as set forth herein that employ the various locationing schemes in connection with various wireless applications (e.g., mobile payment, chain of custody, parcel management, etc.) may correspond to the apparatus for providing wireless communication as set forth in pending U.S. application Ser. No. 16/777,479 (“the '479 application) entitled “SYSTEM, APPARATUS, AND METHOD FOR PROVIDING WIRELESS COMMUNICATION AND A LOCATION TAG” as filed on Jan. 30, 2020 the disclosure of which is hereby incorporated by reference in its entirety.

Urban environments are typically covered by a dense infrastructure of fixed transceivers for wireless communications, such as Wi-Fi® access points and cellular microcell and picocell base station transceivers. Such transceivers are deployed by wireless service providers in order to support communications with subscriber devices. Aspects provided herein may determine location coordinates of wireless transceivers. These location coordinates may be used, for example, in navigation applications (particularly indoor navigation), as well as in tracking the locations of people and other assets.

### System Description

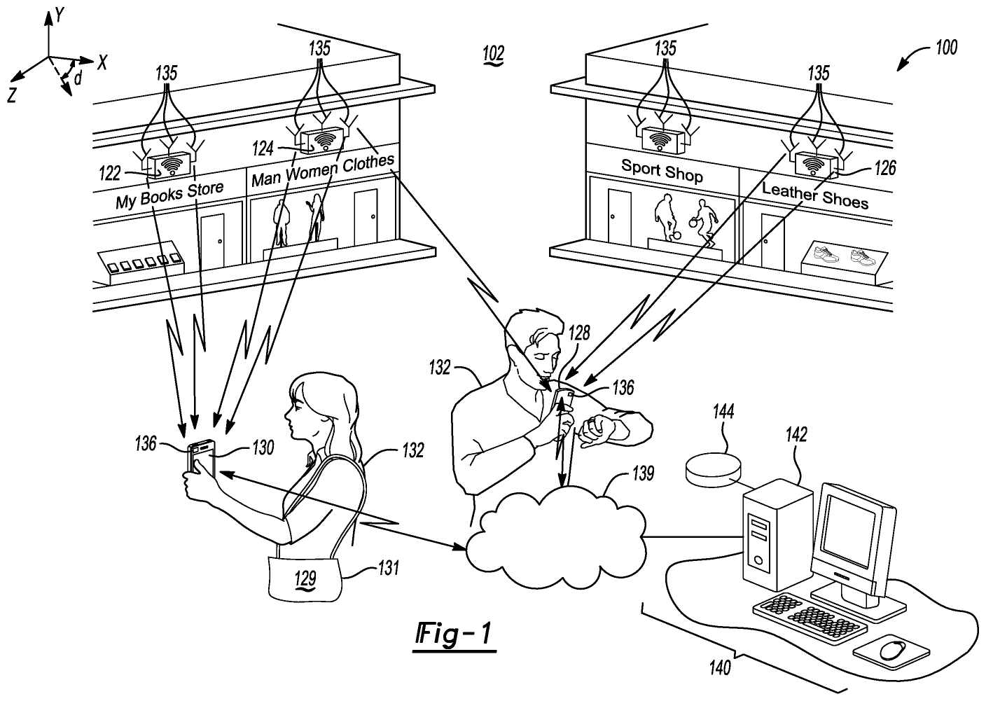

FIG. 1 is schematic, pictorial illustration of a system 100 for wireless communications and position finding, in accordance with an embodiment of the invention. By way of example, FIG. 1 shows a typical environment, such as a shopping mall or street, in which multiple access points 122, 124, 126 are deployed, often by different WLAN proprietors independently of one another. It is recognized that the number of access points 122, 124, 126 may vary. Signals transmitted by the access points 122, 124, 126 are received by receivers in the form of mobile devices 128, 130 which are operated by users 132. The users 132 are free to move around within the area covered by system 100. In the illustrated embodiment, the mobile devices 128, 130 are shown as cellular phone; but other sorts of mobile transceivers, such as laptop, tablets computers, wearable electronic devices (e.g., smart watches), etc. may be used in similar fashion and can similarly find angles from departure of access points 122, 124, 126 as described hereinbelow. It is recognized that the number of mobile devices 128, 130 may also vary. It is also recognized that the mobile device 128 may also correspond to a location tag 131 that includes a wireless transceiver and other electronic circuitry that is arranged for attachment to an object 129. For example, the object 129 may correspond to a women's handbag (or purse) and the location tag 131 may provide information indicative of the location of the handbag 129. The location tag 131 may transmit information corresponding to the location of the object to one or more access points 122, 124, 126 and/or to at least one server 140. Each mobile device 128, 130 generally includes a MODEM or other apparatus for enabling wireless communication with the various access points 122, 124, 126 in the environment.

The access points 122, 124, 126 may find angles of arrival of signals transmitted by the mobile devices 128, 130. Each of access points 122, 124, 126 in system 100 is assumed, for example, to have two or three antennas 135, as shown in FIG. 1. The number of antennas 135 may vary in the system 100. The mobile devices 128, 130 are each assumed to have a single, omnidirectional antenna 136, although the techniques described herein for detecting angles can similarly be implemented by multi-antenna stations.

The mobile devices 128, 130 process signals received from antennas 135 to estimate the angles of departure of the signals from the respective access points 122, 124, 126 as well as to extract an identifier (such as the Basic Service Set Identifiers (BSSID)) with regard to each access point 122, 124, 126. The angles of departure in the coordinate frame of the access points 122, 124, 126 (e.g., identified a in FIG. 1) may be computed in two dimensions, assuming the access points 122, 124, 126 and mobile devices 128, 130 are in proximity to a common plane, or in a three-dimensional coordinate system. The mobile devices 128, 130 perform these functions, as described further hereinbelow, without necessarily wirelessly associating with the access points 122, 124, 126.

On the other hand, mobile devices 128, 130 may associate with one or more of access points 122, 124, 126 for purposes of Internet communications. Alternatively or additionally, the mobile devices 128, 130 may access the Internet via a cellular network or other connection. In any case, the mobile devices 128, 130 communicate the angle-of-departure data and access point identification that they collect via a network 139 to a mapping server 140. This information may be collected and reported autonomously and automatically by a suitable application program (“app”) running in the background on the mobile devices 128, 130. Alternatively or additionally, the access points may compute and communicate angle-of-departure data to the server 140 for the purpose of finding locations of the mobile devices 128, 130.

The server 140 includes a programmable processor 142 and a memory 144. The functions of server 140 that are described herein are typically implemented in software running on processor 142, which may be stored on tangible, non-transitory computer-readable media, such as optical, magnetic or electronic memory media.

In other embodiments, a location-tracking device based on the principles described herein may be embedded into or attached to assets and is used by server 140 in automatically tracking the locations of these assets. Non-limiting examples of such assets include cellular telephones, robots, hospital beds, medical equipment, and inventory items. Accurate real-time indoor and outdoor location-tracking of this type may be advantageous in many scenarios, such as ensuring the wellbeing of people in medical care; safely operating robots and drones in their working environments; tracking assets worldwide, for example for purposes of insurance coverage; improving the effectiveness of marketing campaigns to people in public spaces, for example shopping malls and sports stadiums; and facilitating safe driving in urban environments and parking garages. Additional examples include mobile payment via the mobile devices 128, chain of custody, parcel management, ride share rendezvous, etc.

### Interferometric Methods For Estimating Angle of Departure

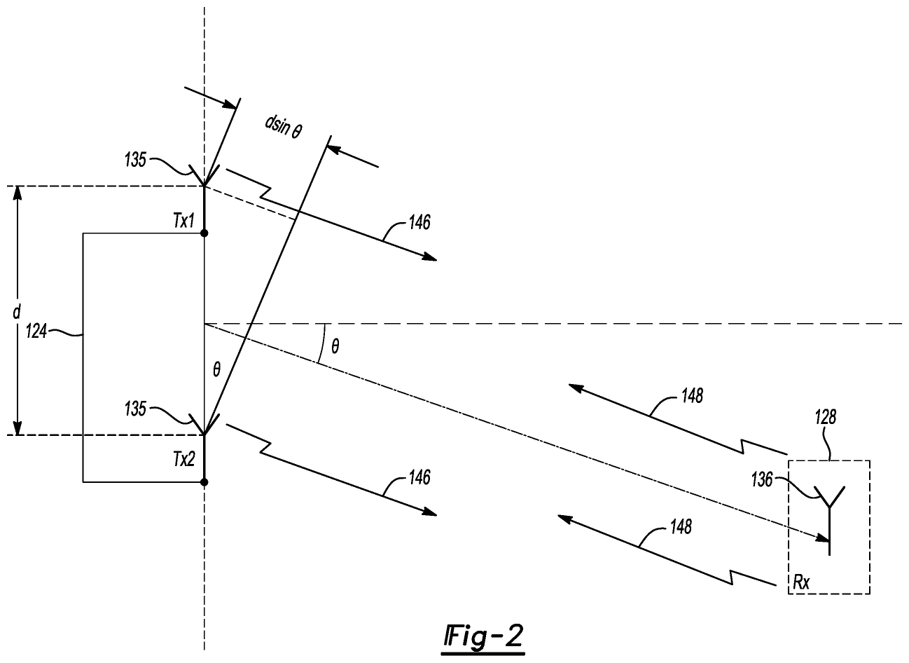

FIG. 2 corresponds to a diagram that schematically illustrates a coordinate frame used in deriving an angle of wireless signals transmitted between access point 124 and mobile device 128, in accordance with an embodiment. This particular pair of an access point and a mobile device is selected purely for convenience, and similar principles will apply to any given pair. Although access point 124 is shown as having two antennas 135 (labeled Tx1 and Tx2), the same geometrical principles apply to access points having three or more antennas arranged in a linear array. The description that follows relates specifically to the angle of departure of downlink signals 146 that are transmitted from antennas 135 of the access point 124 to the mobile device 128; but the principles of this and the subsequent embodiments may similarly be applied in finding the angle of arrival of uplink signals 148 from mobile device 128 that are received by antennas 135.

The antennas 135 define an array axis as the line passing through the bases of the antennas 135. The antennas 135 are separated along the array axis by a known inter-antenna distance d. (The array axis is the line running through antennas 135—shown as a vertical dashed line in FIG. 2.) In wireless access points, for example, the distance d is designed to be a half wavelength, for example, γ/2=6.25 cm at the standard Wireless Local Area Network (WLAN) transmission frequency of 2.4 GHz, wherein γ is the wavelength of the radio signals. Alternatively, transmitters in embodiments thereof may have larger or smaller values of d (and correspondingly, larger or smaller ratios between the inter-antenna distance and the wavelength). The angle of departure θ of the signals from antennas 135 to antenna 136 of the mobile device 128 is taken relative to the normal to the array axis, as shown in FIG. 2. Assuming the distance from access point 124 to mobile device 128 to be considerably greater than d, there will be a difference of d*sin θ in the path length from Tx1 to antenna 36 (referred to as Rx) relative to the path length from Tx2.

As an example, assuming the length of the path from Tx2 to Rx is 6.0000 m, θ=30°, the slightly longer path from Tx1 to Rx will be 6.03125 m. This path difference translates into a 90O phase difference: Δφ=d sin(π/6)=(λ/2*1)/2=λ/4. The phase difference varies with angle, as well as with the wavelength (or frequency) of transmission.

In general, a receiver such as mobile device 128 measures the carrier phase difference (CPD) between the radio signals received from the different antennas 135 of each of a number of different transmitters (or access points 122, 124, 126) at different locations. Various methods may be applied in measuring the CPD. For example, assuming the radio signals emitted from both of antennas 135 are both modulated with a given sequence of symbols, the mobile device 128 may compute the CPD by identifying a given symbol in the sequence in each of the radio signals that the mobile device 128 receives and measuring the delay in arrival of the given symbol between the radio signals. When the radio signals from both antennas 135 encode identical data using a multi-carrier encoding scheme (such an OFDM scheme) with a predefined cyclic delay between the signals, the known cyclic delay can readily by applied in detecting the phase difference. Techniques of this sort for measuring CPD, and thus the angle of departure, may be disclosed in International Patent Application PCT/IB2017/055514.

As another example, the receiver may detect a predefined training sequence in the radio signals transmitted from antennas 135 and may measure the times at which a certain symbol in the training sequence reaches the receiver from each of the transmitters.

Modern wireless standards may specify certain training fields that are to be transmitted in the preambles of data frames that are transmitted by wireless transceivers, such as the access points 122, 124, 126, and define procedures by which a mobile device 128 or 129 may estimate channel state information between each of the antennas 135 and the antenna 36 based on the training fields in the received radio signals. For example, the preambles of frames that are transmitted in accordance with the IEEE 802.11n standard (as well as later standards in the 802.11 family) include multiple instances of the high-throughput long training field (HTLTF), one for each antenna 135. The receiver processes these fields in order to compute a matrix of complex values of channel state information {CSIi,j}, representing the amplitude and phase of the channel response for each antenna i in each frequency bin j. The difference between the phase components of the CSI for the different antennas 135 in a chosen bin gives the CPD. For example, assuming the access point 124 has two antennas 135 (so that i=0,1):

CPD= [symbol] CSI [symbol] _(0,j)− [symbol] CSI [symbol] _(1,j)

As a further example, if the receiver (e.g., mobile device 128, 130) itself has multiple antennas 136, it may apply phased detection in distinguishing the signals received from each of antennas 135 of the transmitter (i.e., access point 122, 124, 12), and thus measure the CPD between the signals.

Regardless of the method by which the CPD is measured, it is related to the angle of departure θ (FIG. 2) by the following formula, which expresses an interferometry model:

CPD=(2πd/λ sin θ)mod 2π

The ranges of both the angle of departure and the CPD are 0, 2π, but the functional relation is not one-to-one: At least two values of θ transform into the same CPD: If θ is a solution, so is π−θ. When 2d/λ≤1, there are exactly two possible solutions (θ, π−θ mirroring each other along a line crossing the array axis. (Although FIG. 2 shows only a single solution, as a ray extending from access point 124 to mobile device 128, there is, in addition, a second solution mirrored by the line crossing the array axis.) When 2d/λ>1, four or more solutions are possible (as the argument in the modulo exceeds 2π when the sine spans (−1,1]), defining rays emanating from the transmitter. The number of solutions may be even.

### Location-Finding Using CPD

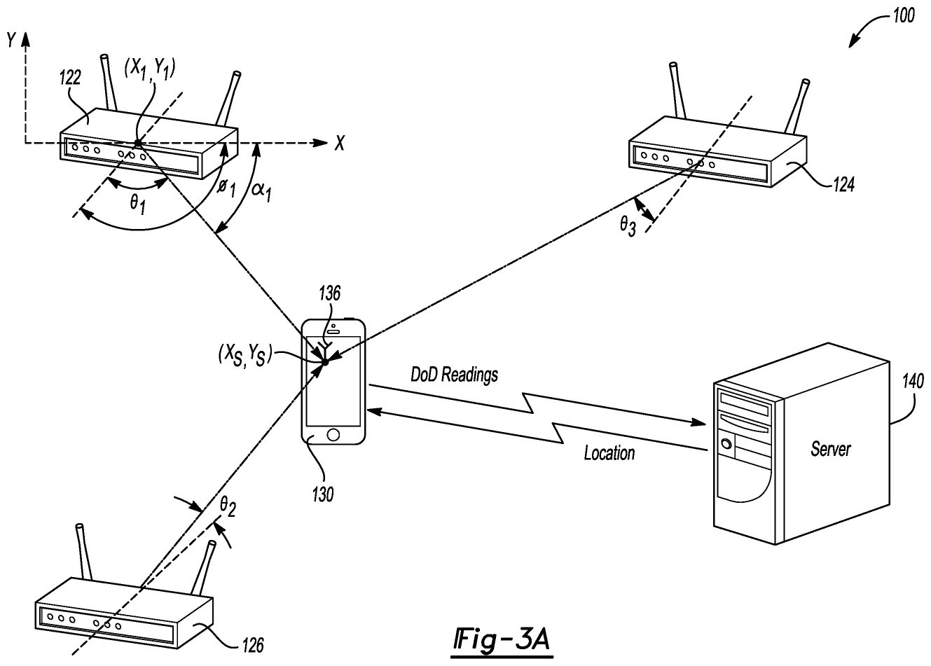

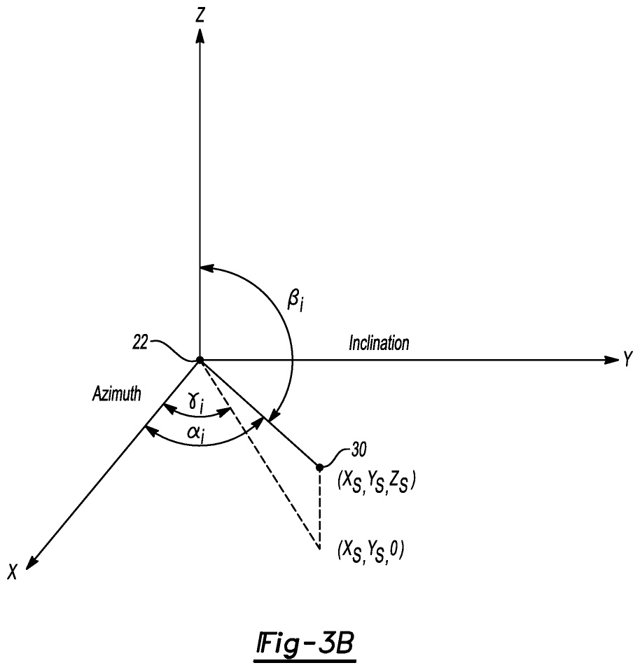

FIG. 3A is a schematic, pictorial illustration of components of the system of FIG. 1, illustrating a method for finding the position of mobile device 130, in accordance with an embodiment. This method assumes that the respective location coordinates (labeled xᵢ, yᵢ) and BSSIDs of access points 122, 124 and 126 have already been mapped by server 140, in a frame of reference indicated by the (X,Y) axes in the figure. The map also indicates a respective orientation angle (ϕᵢ) for each access point 122, 124, 126, in this case the direction of a normal to the axis of the antenna array of each access point 122, 124, 126. The method of FIG. 3A uses angles of departure in a two-dimensional frame of reference (assuming the access points 122, 124, 126 and mobile device 128, 130 to be in proximity to a common plane, as explained above). Alternatively, this method may use angles of arrival measured by the access points 128, 130; and it may be extended to three dimensions, at the expense of some additional geometrical complication, as explained below.

In some embodiments, the map is constructed on the basis of measurements of angle of departure that were made previously by other mobile devices 128, 130 and/or other input data. The mobile devices 128, 130 in this case report their locations and the estimated angles of departure to server 140, along with respective identifiers of the access points 122, 124, 126, and the server 140 constructs the map accordingly. The server 140 may build this access point map without requiring any cooperation by operators of the access points 122, 124, 126. Alternatively or additionally, the map may incorporate information provided by network operators and/or physical measurements made using dedicated equipment.

In the embodiment of FIG. 3A, the mobile device 130 receives multi-antenna signals from each of the access points 122, 124 and 126. The mobile device 130 extracts the respective angle of departure for each access point, labeled θ₁, θ₂, and θ₃ in the figure, using the techniques described above, along with the respective BSSIDs (or MAC addresses). The mobile device 130 reports these findings via network 138 (FIG. 1) to server 140, which returns corresponding location coordinates. The server 140 may return the location coordinates and orientation angles of the access points (xᵢ,yᵢ, ϕᵢ), in which case the mobile device 130 can triangulate its own position (xₛ,yₛ) based on these coordinates and the measured angles of departure. Alternatively or additionally, the mobile device 130 conveys the values of the angles of departure that the mobile device 130 has estimated to server 140, which then computes and returns the location coordinates to mobile device 130.

The location coordinates of mobile device 130 are computed by a process of CPD-based triangulation: Each CPD measurements defines two (or more) loci in a common plane to which access points 122, 124, 126 and the mobile device 130 are in proximity. The loci have the form of rays extending through the plane from the respective location coordinates (xi,yi) of the access points, in the fixed frame of reference of the map, at angles αi, defined by ϕᵢ=θᵢ+αᵢ, as given by the respective orientation angle (ϕᵢ) and the measured angle of departure (θᵢ) from each of the plurality of the transmitters. The location coordinates (xₛ,yₛ) of mobile device 130 correspond to an intersection of these rays, as shown in FIG. 3A. As in the case of FIG. 2, the ambiguity in the translation of CPD measurements to angle of departure is omitted from FIG. 3A for the sake of simplicity.

FIG. 3B is a diagram that schematically illustrates a method for finding the location of mobile communication device 130, in accordance with an alternative embodiment. In this case, the angles αᵢ, ϕᵢ and θᵢ are extended to three dimensions. For example, in a spherical coordinate system, as shown in FIG. 3B, the angle αᵢ will have both an inclination component βi and an azimuth components γᵢ, which are related by the formula cos (αᵢ)=sin(βᵢ) cos(yᵢ). In this case, the loci defined by the CPD values will have the form of curves, rather than linear rays, and the intersection of these curves gives the location of mobile device 130.

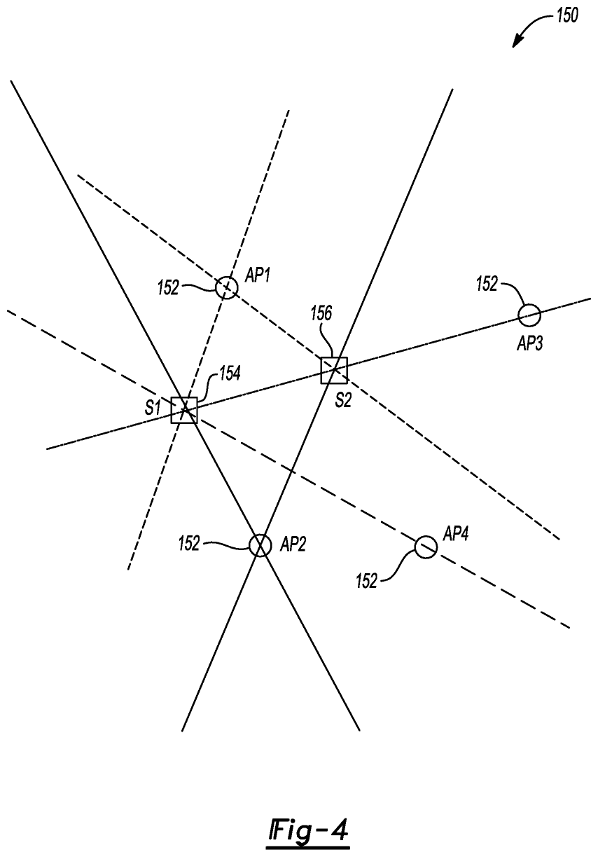

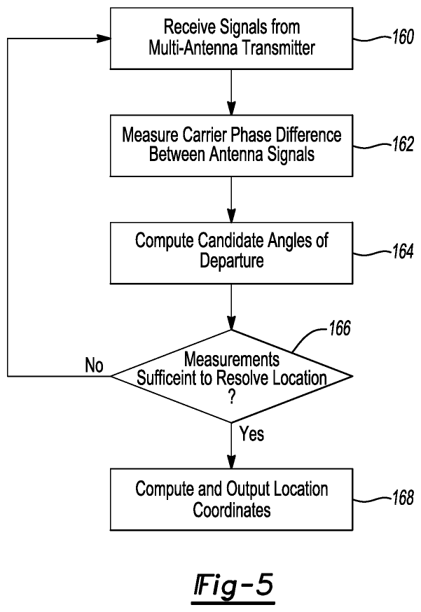

Reference is now made to FIGS. 4 and 5, which schematically illustrate a method for location finding based on multiple fixed transceivers, in accordance with an embodiment. FIG. 4 is a geometrical diagram of an area 150 showing the locations of fixed transceivers marked as transmitters 152 in the area (marked AP1, AP2, AP3, AP4), while FIG. 5 is a flow chart showing operations in the method. For simplicity of illustration, FIG. 4 assumes a two-dimensional model and shows the loci corresponding to the CPD values as linear rays, corresponding to angles of departure of signals from transmitters 152 to the receiver in a mobile transceiver. This method may alternatively be extended to three dimensions and may similar be applied to values of angle of arrival, using the principles explained above.

The computing steps in this method may be carried out either by a central processor, such as the processor 142 in server 140 (FIG. 1), or by a processor embedded in the receiver, such as in mobile devices 128, 130 or in a distributed fashion among multiple processors. The term “processor,” may be defined to include both local and distributed processors running under the control of software, as well as dedicated and programmable hardware-based processing logic.

A receiver, such as the mobile device 130, receives signals from a multi-antenna transmitter, for example AP1, at a signal reception (e.g. see operation 160). The receiver measured the CPD of the received signals in the manner described above, at a CPD measurement operation 162. Based on the formula above, the receiver derives two or more possible angles of departure with respect to the transmitter, at an angle computation step 164. In the example shown in FIG. 4, AP1 is assumed to have an inter-antenna distance d that is larger than the wavelength of the radio signals transmitted by AP1, 2d/λ>1. The CPD measured for AP1 therefore gives rise to four candidate angles of departure, which are represented by the four rays emanating from AP1 in the plane of the figure (two pairs of rays, with the two rays in each pair pointing in opposite directions, 180° apart).

In formal terms, each of the rays has a slope aᵢ=tan αᵢ in the frame of reference of the map, wherein ϕᵢ=θᵢ+αᵢ, as shown in FIG. 3A. Assuming AP1 to be located at known coordinates (xᵢ,yᵢ) and the receiver to be at unknown coordinates (xₛ,yₛ), each of the rays defines a corresponding linear equation: yᵢ=aᵢ (xᵢ−xₛ)+yₛ. The mobile device 130 or the server 140 (depending on where the location-finding process is carried out) checks whether the measurements and corresponding equations that have been assembled thus far are sufficient to resolve the location of mobile device 130 unambiguously, at a measurement assessment operation 66. If not, the process returns to operation 160, and the measurements and computations are repeated over additional transmitters.

FIG. 4 illustrates the situation at operation 166 after a number of successive iterations. After receiving signals and finding the candidate angles of departure from AP1, AP2 and AP3, there are still two possible locations 154 and 156 of mobile device 130, labeled S1 and S2. The processor will thus conclude at operation 166 that further measurements are required and will seek to receive signals from yet another transmitter at operation 160, in this case AP4. These signals indicate unambiguously that the mobile device is located at S1. The processor will then compute and output the location coordinates of the mobile device 130, at a location output operation 168. Alternatively, the mobile device 130 may collect and process signals from a larger number of transmitters, if available, which will result in an overdetermined set of equations, but can be used to increase the measurement accuracy.

### Modem

FIG. 6 depicts an apparatus 200 that may be implemented in the wireless communication system 100 of FIG. 1 in accordance to one embodiment. For purposes of description, it can be assumed that the access point 122 may communicate with the mobile device 128 (or 130) (hereafter “128” for brevity unless otherwise stated) over a first communication network (e.g., WIFI network A, channel 1 @ 2.4 GHz), that the access points 124a and 124b may communicate with the mobile device 128 over a second communication network (e.g., WIFI network B @ channel 6 @2.4 GHz), that the access point 126a may communicate with the mobile device 128 over a third communication network (e.g., a Long-Term Evolution (LTE) network A @ 1.9 GHz) and that the access point 126b may communicate with the mobile device 128 over a fourth communication network (e.g., LTE network B @ 1.9 GHz).

The mobile device 128 generally includes a modem 201 (or modem chip (e.g., integrated chip (IC), etc.)). The modem 201 generally facilitates converting analog information as received from the access points 122, 124, 126 into digital information. The modem 201 includes a transceiver 202, a downconverter 204, an analog to digital converter (ADC) 206, memory 208, and at least one central processing unit (CPU) (or at least one controller) 210. A dedicated modem chip 212 (or sub-modem) may also be provided on the modem 201. In this case, the dedicated modem chip 212 may correspond to, for example, an LTE based modem to enable communication with the various LTE based networks or associated access points. A bus 213 facilitates the transmission of data between the ADC 206, the memory 208, and the controller 210. In one example, the bus 213 may be an Advanced Microcontroller Bus Architecture (AMBA) bus that may be employed in a system-on-a-chip (SoC) design.

It is recognized that the modem 201 generally facilitates communication, for example, any number of communication networks (e.g. WiFi and LTE based networks). At least two spatially overlapping network types (e.g., a first LTE network and a second LTE network) that are owned by different service providers that the mobile device 128 has no service contracts with (i.e., needs a contract with the LTE operator of a backhaul), hence may not interact with. In addition, a large collection of foreign WiFi networks, the mobile device 128 has no access to, may be spectrally spread across, for example, the ISM 2.4 GHz band. It may be desirable for the mobile device 128 to process information as received via the first or second communication network (e.g., WiFi) as opposed to the third or fourth communication network (e.g., LTE) for providing signal components such as Long Training Field (LTF) information to the controller 210 for the purpose of, but not limited to, determining an angle of departure for first and second signals that are transmitted from any one or more of the access points 122, 124, 126.

Assuming, as stated earlier, that the dedicated modem 212 generally corresponds to an LTE based modem, it may be desirable to divert (or bypass) the flow or transmission of information as received from any of the access points 122, 124, 126 at predetermined instances from being received at the dedicated modem 212. For example, the apparatus 200 may process data in the WiFi format to provide locationing functionality. The apparatus 200 may enable processing the data in the WiFi format without any hardware modifications. Specifically, the apparatus 200 may utilize various aspects of the hardware that may not have been used for the purpose of performing such processing in WiFi. This will be discussed in more detail below.

The apparatus 200 may hop between WiFi and LTE processing and generally sets out to provide a locationing capability utilizing the WiFi format (or with data that is transmitted via the access points 122, 124, 126 in the WiFi format). In general, the downconverter 204 is protocol agnostic and can receive signals in either the WiFi or LTE format. The downconverter 204 may be tuned to a center frequency of the received signal of interest which may be different between LTE licenses and WiFi (e.g., unlicensed, ISM). Generally, the controller 210 may administer the downconverter 204 and set the center radio frequency (RF) frequency as required. Normally, the downcoverter 204 is tuned to receive an LTE carrier signal from the access points 122, 124, 126. Aspects of the disclosure generally provide for a reprogramming of the controller 210 with instructions, that when executed by the controller 210 provide for a reprogramming of various hardware registers of the down converter 204. This may entail re-tuning the downcoverter 204 to the corresponding WiFi channel in the 2.4 GHz band. Additional parameters may be re-tuned in response to the controller 210 executing the instructions. For example, such additional parameters may include, but not limited to, radio frequency (RF) gain, channel bandwidth, and a sampling rate. In the WiFi mode of operation, the bandwidth may be set to, for example, 20 MHz and the sampling rate may be set to 20 Mega complex samples per second. In attempting to process information in the WiFi format to provide the location capability with the components illustrated in FIG. 2, such a condition may increase processing load for the controller 210. To mitigate this issue, the controller 210 may take advantage of Beacon packets that are generally inserted in the WiFi based signal to reduce computational load of the controller 210.

It may be necessary to downconvert frequencies associated with LTE and WiFi. For example, high frequency signals, typically above 100 MHz may not be sampled directly due to technical limitations such as, for example, the circuitry may not be fast enough. The electronics may be incapable of capturing analog signals that rapidly vary in time. For example, 100 MHz signals require capturing time intervals smaller than 10 nano seconds. Further, the captured analog signals may be quantized to typically 12 data bits (i.e., quantized to one of 2\hat{ }12=4096 threshold levels) which may be challenging at rates faster than 100 Mega samples per second. Typically, the bandwidth of the signals at hand may be smaller than the highest frequency component of the signal. For example, a 20 MHz Wifi signal at channel 36 populates frequencies between 5170 MHz and 5190 MHz. Instead of sampling a bandwidth of 5190 MHz, the signal may be downconverted to Zero IF into a signal populating frequency between −10 and +10 MHz. This baseband signal may be sampled at a rate of 20 Mega complex samples per second. Thus, downconversion may solve both the issues associated with analog capture and digital conversion.

The apparatus 200 (i.e., the downconverter 204) may perpetually switch between LTE and WiFi. The transceiver 202 receives the LTE based information at, for example, 1.9 GHz or other suitable frequency. The transceiver 202 provides such information to the downconverter 204. In turn, the downconverter 204 (or the zero_IF 204) provides a baseband, either the LTE signal or the WiFi signal are each converted to baseband. When receiving and processing the current beacon packet in the WiFi mode, the next beacon packet epoch may be determined. In a time period between the reception of the current beacon packet at the apparatus 200 and the next beacon transmission (based on the beacon epoch), the apparatus 200 processes this small amount of data. This may require more time than real-time, given the CPU power on chip. If the received thread is cut, the downconverter 204 may, for example, continuously receive WiFi for at least one Beacon Interval of typically 102.4 ms and reacquire contact with beacon epochs of the access points 122 for example.

When the apparatus 200 is tuned to a WiFi band, it is generally desirable to bypass (or prevent) the dedicated modem 212 from receiving this information. Rather, it may be preferable for such received information in the WiFi mode to be transmitted directly to the memory 208 (i.e., for storage) to enable the controller 210 to access and process such information. For example, the downconverter 204 generates an output that is in the form of samples that are complex numbers called a complex envelop. This raw data may be fed to the dedicated modem 212 (e.g. an LTE modem) when an LTE based signal is received or to the memory 208 when the WiFi based signal is received. The controller 210 processes the data from the memory 208 after the memory 208 receives the raw data. To ensure that the above condition is met, particularly in relation to ensuring that the WiFi based samples are transmitted directly to the memory 208 and not to the dedicated modem 212, the apparatus 200 incorporates a bus 213 which may by nature facilitates read and write access to data on the bus to all attached devices. In this case, the bus 213 may be implemented as an AMBA bus to cause the samples received in the WiFi format to be transmitted directly to the memory 208 after being received and downconverted.

In general, code may be stored in memory 208 and/or the controller 210 that facilitates the bypass or prevents the WiFi based samples from being transmitted to the dedicated modem 212 (e.g., ensures the transmission of WiFi beacons to the memory 208 for access by the controller 210). Such code may be part of the code that may be stored in the controller 210 (and/or memory 208) and provides for a reprogramming of various hardware registers of the down converter 204 as noted above. The code, when executed by the controller 210 may engage (or program) the AMBA bus 213 (or other suitable variant thereof) to provide the WiFi based samples directly to the memory 208 and then to the controller 210 via the memory 208 to support locationing functionality. This aspect may negate the use of performing a hardware change to the modem 202. For example, the reprogramming of the controller 210 may also enable the ADC 206 to locally transmit data as received on a WiFi signal directly to the memory 208 for access by the controller 210 as opposed to such data being delivered to the dedicated modem 212. The controller 210 reprograms the ADC 206 to change the address for the delivery of WiFi data from the dedicated modem 212 to an address for the memory 208. The controller 210 may then access the WiFi data from the memory 208 to process such information. The AMBA bus 213 is generally used for the limited purpose of calibration of the ADC 206 (i.e. when the apparatus 200 is in a calibration mode). However, an advantage recognized by the disclosed implementation is the utilization of the AMBA bus 213 to transfer real WiFi based data directly to the memory 208 for processing by the controller 210 to enable the apparatus 200 to providing locationing capability. The AMBA bus 213 generally prevents the downconverter data samples from being transmitted to the dedicated modem 212.

In general, the modem 200 may perform any of the locationing aspects as disclosed herein in addition to any of the providing wireless applications based on locationing solutions as disclosed herein in addition to various wireless applications that include, but not limited to, mobile device payments, mobile chain of custody, and mobile parcel management based on the locationing aspects.

### Propagation Time Measurement Scheme (Time of Flight)

### Determining the Location of a Receiver

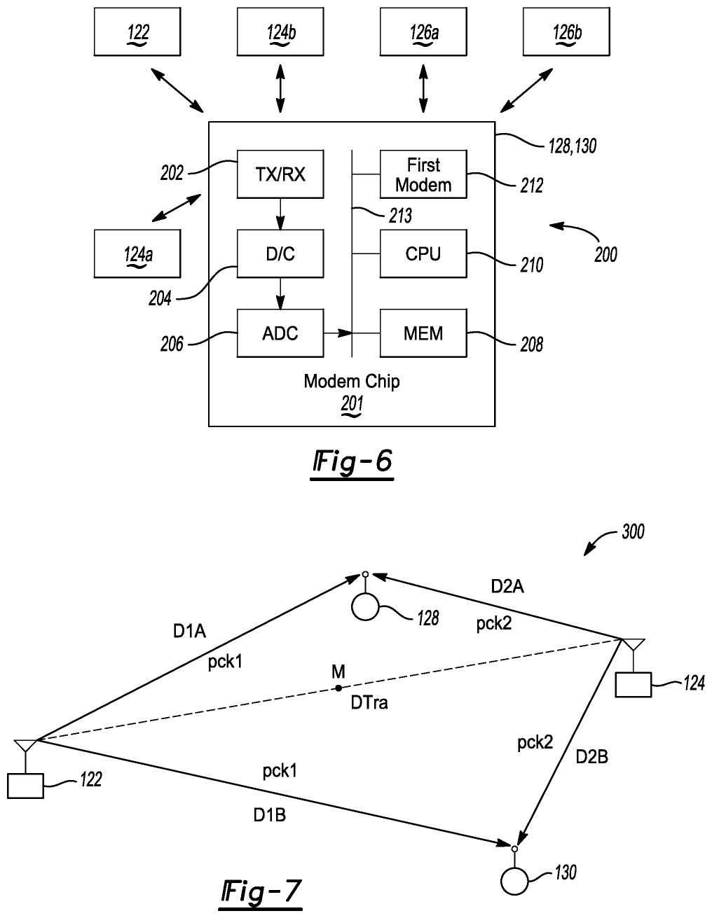

FIG. 7 generally depicts a first system 300 for determining the location of any one of the mobile devices 128 or 130 relative to the access points 122, 124, 126 in accordance to one embodiment. In the example identified with the first system 300, the access points 122, 124, 126 may generally be defined as transmitters 122, 124, 126 and the mobile devices 128, 130 may generally be defined as receivers 128, 130. The location of the receiver 128 or 130 and the location of the transmitters 122, 124, 126 are known prior to determining the location of the other receiver 128 or 130. The mobile device 128, 130 cooperate in pairs such that each mobile device 128, 130 determines its corresponding location. It is recognized that the mobile device 128, 130 may be passive in that such devices 128, 130 may determine their respective locations based on transmissions from the access points 122, 124, 126 and that it may not be necessary for the mobile devices 128, 130 to transmit data to the access points 122, 124, 126 to determine their respective positions.

The transmitters 122, 124, 126 (e.g., the access points 122, 124, 126) and the receivers (e.g., the mobile devices 128, 130) may employ autonomous, inaccurate clocks. In other words, each of the transmitters 122, 124, 126 and the receivers 128, 130 employ controllers 210 that operate at different clocks (or clock cycles). In order to overcome the inaccurate clocks, the receivers 128, 130 operate in pairs such that each of the receivers 128, 130 receive a first packet (e.g., PCK1) from the transmitter 122 and a second packet (e.g., PCK2) from the transmitter 124. It is recognized that the receivers 128, 130 receive the second packet PCK2 shortly after such receivers 128, 130 receive the first packet PCK1. The following explanation employs a pair of transmitters that transmit information. In FIG. 3, a total of three transmitters 122, 124, and 126 are illustrated. Thus, the below process is employed for each pair of transmitters (e.g., first pair of transmitters 122, 124, second pair of transmitters 122, 126, and third pair of transmitters 124, 126). This will be discussed in more detail in connection with FIG. 10.

The receiver 128 estimates the time of arrival of the first packet PCK1 and the second packet PCK2 utilizing its own internal clock based on the following:

$${t}_{p c k 1} + \frac{{D}_{1 A}}{c} + {t}_{A} and {t}_{p c k 2} + \frac{{D}_{2 A}}{c} + {t}_{A} for PCK 1 and PCK 2 , respectively . \qquad ( Eq . 1 ) .$$

The receiver 128 calculates (or determines) the first difference in time of arrival (e.g., first difference) between the first packet PCK1 and the second packet PCK2 based on the following:

$$Δ {t}_{A} = {t}_{pck 2} - {t}_{pck 1} + \frac{{D}_{2 A} - {D}_{1 A}}{c} which is independent of local receiver clock {t}_{A} for the receiver 128 , \\ where c corresponds to the speed of light . \qquad ( Eq . 2 )$$

Similarly, the receiver 130 estimates the time of arrival of the same first packet PCK1 and the same second PCK2 utilizing its own internal clock based on the following:

$${T}_{B} ( or Δ {t}_{B} ) = {t}_{pck 2} - {t}_{pck 1} + \frac{{D}_{2 B} - {D}_{1 B}}{c} which is independent of local receiver clock {t}_{B} for the receiver 130. \qquad ( Eq . 4 )$$

The receiver 130 calculates (or determines) the difference in time of arrival (e.g., the second difference) between the first packet PCK1 and the second packet PCK2 based on the following:

$${t}_{pck 1} + \frac{{D}_{1 B}}{c} + {t}_{B} and {t}_{pck 2} + \frac{{D}_{2 B}}{c} + {t}_{B} for PCK 1 and PCK 2 , \\ respectively . \qquad ( Eq . 3 )$$

Therefore, the final difference between the first difference and the second difference may be found as follows:

$$Δ {t}_{BA} = Δ {t}_{B} - Δ {t}_{A} = \frac{( {D}_{2 B} - {D}_{1 B} ) - ( {D}_{2 A} - {D}_{1 A} )}{c} . \qquad ( Eq . 5 )$$

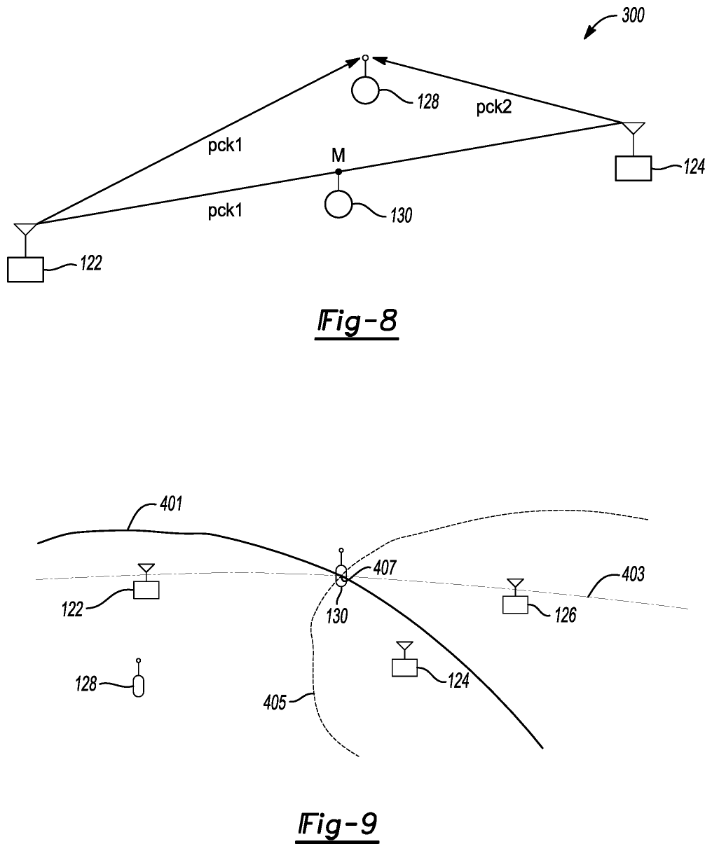

FIG. 8 generally depicts another aspect related to the first system 300 for determining the time of arrival in accordance to one embodiment. The receiver 130 is positioned at a location that is half-way between the transmitter 122 and the transmitter 124. In general, the second difference (see. Eq. 5) as determined by the receivers 128, 130 is generally equal to a time difference between the transmitted first and second packets (e.g., PCK1 and PCK2) since a propagation delay from the transmitters 122, 124 to the receiver 130 are similar (e.g., D1A=D2A). It is recognized that the embodiment illustrated in FIG. 7 is a general case and the embodiment illustrated in FIG. 8 corresponds to a particular case.

The receiver 128 transmits information corresponding to the time difference between the transmitted first and second packets (e.g., PCK1 and PCK2) to the receiver 130 and/or to the server 140. In one example, the receiver 128 transmits such information to the receiver 130 over a potentially poor-quality network. In other words, the receivers 128, 130 share their respective readings over a backhaul which may be of a high, unpredictable latency. In general, there may not be any out of the ordinary requirements from the backhaul for the first system 300 to operate as intended. For example, a Narrowband Internet of Things (NB-IoT) or LTE data network may operate well in the first system 300. The receiver 130 subtracts the time difference between PCK1 and PCK2 sent by the transmitters 122, 124 respectively as reported by the receiver 128 from its measured time difference. To summarize, the first difference and the second difference performed by the receivers 128, 130, eliminates the unknown local clock skew in the receivers 128, 130. The third difference (or the difference of the differences) eliminates the unknown clock skew between the transmitters 122, 124. The residue is proportional to propagation delays only.

In general, in the case in which the location of the transmitters 122, 124 and the receiver 128 is known, and hence, D_{2A}−D_{1A} and D_{Tra}=D₂₁ are known, the receiver 128 transmits Ata (e.g., the time difference between the first packet (PCK1) and the second packet (PCK2) as transmitted from the transmitters 124 and 126 and received at the receiver 128) to the receiver 130 or server 140 which forwards the reading to the receiver 130. The receiver 130 measures Δt_{B} (e.g., the time difference between the first packets (PCK1) and the second packets (PCK2) as transmitted from the transmitters 122 and 124 and received at the receiver 130) and as per Eq. 5 calculates:

ΔD_{B}=D_{2B}−D_{1B}=c(Δt_{A}−Δt_{B})+(D_{2A}−D_{1A}) (Eq. 6)

FIG. 9 generally depicts that the location of the receiver 130 may be a point on a singular hyperbola having a foci at the transmitter 124 and at the transmitter 126 with an eccentricity of:

$$e = \frac{{D}_{Tra}}{Δ {D}_{B}} \qquad ( Eq . 7 )$$

Where D_{Tra} is the distance between the transmitters 124 and 126 (the foci) as the location of these transmitters 124 and 126 and the receiver 128 are known.

Generally, FIG. 9 depicts identifying three hyperbolas that intersect a single point. Each hyperbola is associated with location information associated with pairs of transmitters (e.g., transmitters 122, 124; transmitters 122, 126; and transmitters 124 and 126) and the receiver 128. The hyperbolas and pairs of transmitters will be discussed in more detail below.

FIG. 10 depicts a method 400 for determining a location of the receiver 130 in accordance to one embodiment of the present invention. The method 400 generally employs the TOF techniques as set forth in FIGS. 7-9 as noted above. For the method 400, the location of the transmitters 122, 124, 126 and the receiver 128 is known to the server 140. The method 400 utilizes the location of the transmitters 122, 124, 126 and the receiver 128 to determine the location of the receiver 130.

For operations 402, 404, 406, 408, 410, 412, 414, 416, and 418, the method 400 utilizes location information for the two transmitters 122, 124 and the receiver 128 to determine a first hyperbola. The foregoing noted operations 402, 404, 406, 408, 410, 412, 414, 416 are re-executed two more times to take into account location information for the following transmitter pairs: 122, 126 and 124, 126 with the same receiver 128.

In operation 402, the first transmitter 122 transmits a first packet of data (e.g., a WiFi based signal) to the first receiver 128 and to the second receiver 130.

In operation 404, the second transmitter 124 transmits a second packet of data (e.g., a WiFi based signal) to the first receiver 128 and to the second receiver 130.

In operation 406, the first receiver 128 calculates a time of arrival for the first packet of data and a time of arrival for the second packet of data based on its local clock (see Eq. 1 above).

In operation 408, the first receiver 128 calculates the first difference in the time of arrival for the first packet of data and the time of arrival for the second packet of data (see Eq. 2) which is independent of the local clock of the receiver 128.

In operation 410, the second receiver 130 calculates a time of arrival for the first packet of data and a time of arrival for the second packet of data based on its local clock (see Eq. 3 above).

In operation 412, the second receiver 130 calculates the first difference in the time of arrival for the first packet of data and the time of arrival for the second packet of data (see Eq. 4) which is independent of the local clock of the receiver 130.

In operation 414, each of the first receiver 128 and the second receiver 130 transmits their corresponding first difference values to the server 140. It is recognized that the first receiver 128 may alternatively transmit its corresponding first difference value to the second receiver 130.

In operation 416, the server 140 (or the second receiver 130) computes a second difference based on Eq. 5.

In operation 418, the server 140 (or the second receiver 130) calculates the eccentricity based on Eq. 7.

In operation 420, the server 140 (or the second receiver 130) calculates a first hyperbola 401 (see FIG. 9) based on the eccentricity as determined in operation 418 and on the location of the transmitters 122, 124, the loci of the hyperbola. In general, to determine the first hyperbola, the eccentricity need be known in addition to the location (loci) of the transmitters 122 and 124. As noted above, the location of the transmitters 122 and 124 are known. Therefore, it is possible to determine the loci and the distance between the transmitters 122 and 124 and calculate e.

In operation 422, the method 400 re-executes operations 402, 404, 406, 408, 410, 412, 414, 416, and 418 two more times. As noted above, the first time that method 400 was executed, information corresponding to the location of the transmitters 122, 124 was utilized. However, it is necessary to investigate all of the transmitter pairs to determine the location of the receiver 130. Thus, the second time operations 402, 404, 406, 408, 410, 412, 414, 416, and 418 are executed, information corresponding to the location of the transmitters 122 and 126 are employed. Further the third time operations 402, 404, 406, 408, 410, 412, 414, 416, and 418 are executed, information corresponds to the location of transmitters 124 and 126 are employed.

In operation 424, the server 140 (or the second receiver 130) calculates a second hyperbola 403 (see FIG. 9) based on the eccentricity as determined in operation 418 and on the distance between the transmitters 122 and 126.

In operation 426, the server 140 (or the second receiver 130) calculates a third hyperbola 405 (see FIG. 9) based on the eccentricity as determined in operation 418 and on the distance between the transmitters 124 and 126.

In operation 428, the server 140 (or the second receiver 130) determines (or locates) a location 407 which corresponds to a point (or intersection) in which the first hyperbola 401, the second hyperbola 403, and the third hyperbola 405 intersect. The server 140 identifies the location 407 as the location of the second receiver 130.

The foregoing solution may be part of the Hyperbolic Navigation Time Difference of Arrival (TDOA) family that can withstand or survive inaccurate WiFi clocks as noted above. Each measurement may provide a corresponding curve or a hyperbola as detailed above. Three such measurements provide a unique solution. Other techniques such as interferometry which may define straight lines that originate at the same transmitter locations (loci), as referenced above, as the loci can be used to intersect with the above hyperbolas and interferometry lines and provide a robust location estimation for an unknown receiver (and an unknown transmitter as discussed below in a dual constellation).

### Determining the Location of a Transmitter

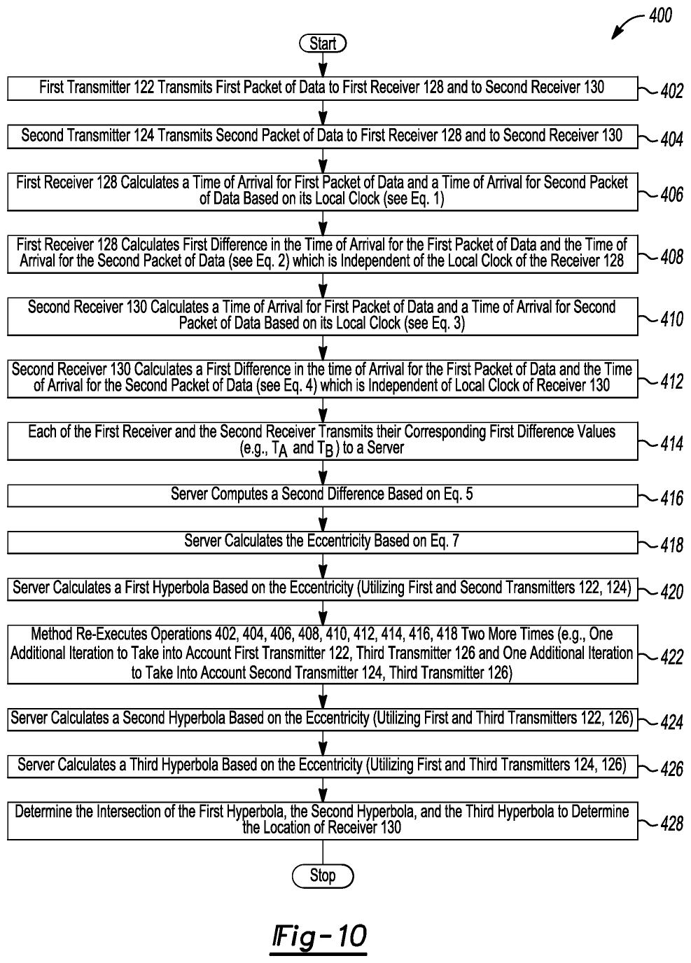

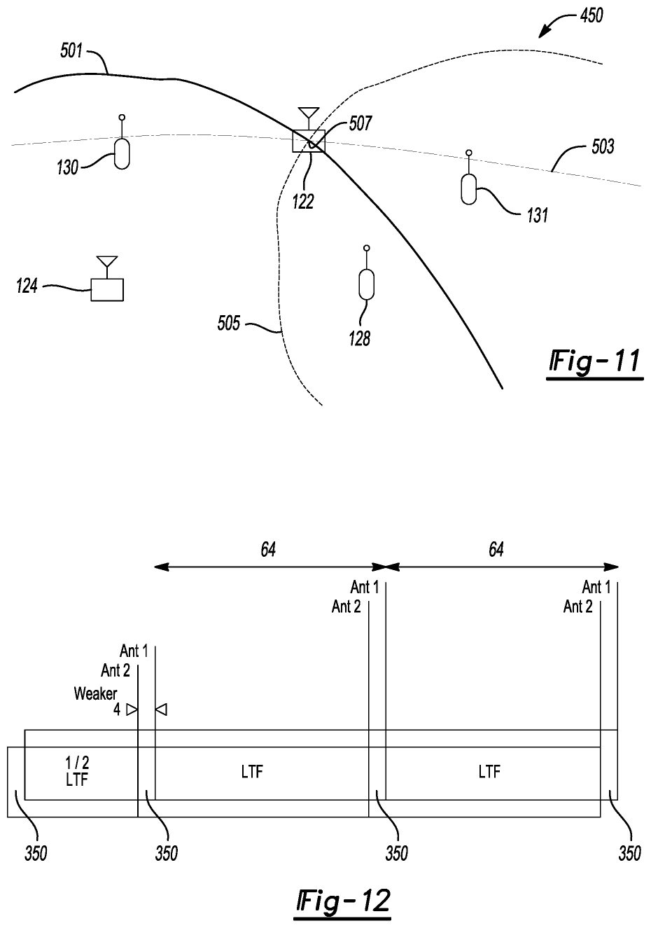

FIG. 11 generally depicts a second system 450 for determining the location of any one of the transmitters 122 or 124 relative to the receivers 128, 130, and 131 in accordance to one embodiment. For purposes of illustration, the location of the transmitter 124 and the receivers 128, 130, 131 are known. Thus, it is desirable to determine the location of the transmitter 122.

The similar analysis as applied in connection with the first system 300 as detailed in connection FIGS. 9 and 10 may be applied to FIG. 11. However, instead of determining the location of the second receiver 130 based on the known location of the first receiver 128 and the transmitters 122, 124, and 126 as set forth in the first system 300, the second system 450 determines the location of the first transmitter 122 based on the known locations of the second transmitter 122, the first receiver 128, the second receiver 130, and the third receiver 131. FIG. 11 illustrates a spatial arrangement of the first transmitter 122, the first receiver 128, the second receiver 130, and the third receiver 131 with respect to the second transmitter 124. It is recognized that the disclosure and various equations as set forth in connection with FIGS. 9 and 10 also apply to the manner in which the location of the first transmitter 122 is determined with various receivers 128, 130 of FIG. 9 being replaced with the transmitters 122, 124 of FIG. 11 and the transmitters 122, 124, 126 of FIG. 9 being replaced with the receivers 128, 130, 131 of FIG. 11.

FIG. 11 illustrates a similar spatial relationship to that illustrated in FIG. 9 with the exception being the placement of the second transmitter 124, the first receiver 128, the second receiver 130, and the third receiver 131 with respect to the first transmitter 122. For example, FIG. 11 depicts that the second receiver 130 replaces the position of the first transmitter 122 as shown in FIG. 9, that the second transmitter 124 replaces the position of the first receiver 128 as illustrated in FIG. 9, that the first receiver 128 as illustrated in FIG. 11 replaces the position of the second transmitter 124 as illustrated in FIG. 9, that the third receiver 131 of FIG. 11 replaces the position of the third transmitter 126 of FIG. 9. FIG. 11 has been illustrated in the manner noted above for purposes of brevity and will not restate the corresponding disclosure and equations also for purposes of brevity.

Thus, in the case as noted above where the location of the first receiver 128, the second receiver 130, and the second transmitter 124 are known, hence the following may be provided:

D_{2A}−D_{2B} and D_{Rec}=D_{AB} are known (see FIG. 6), the first receiver 128 reports Δt_{A} to the second receiver 130, and the second receiver 130 measures Δt_{B} and calculates:

ΔD_{1A}=D_{1A}−D_{1B}=c(Δt_{A}−Δt_{B})+(D_{2A}−D_{2B}) (Eq. 8)

The location of the first transmitter 122 is a point on a singular hyperbola the foci of which are Rec_{A} and Rec_{B} with eccentricity of:

$$e = \frac{{D}_{Rec}}{Δ {D}_{1}} \qquad ( Eq . 9 )$$

The server 140 may perform the calculation of determining the eccentricity. Further, as similarly noted above, the server 140 may calculate the hyperbola for each pair of receivers (e.g., receivers 128, 130; receivers 128, 131; receivers 130, 131)). The server 140 calculates a first hyperbola 501 (see FIG. 8) based on the eccentricity as determined in Eq. 9 and on the distance between the receivers 128, 130. In general, to determine the first hyperbola, the eccentricity need be determined, in addition to the knowledge of the location of the receivers 128, 130, the loci of the hyperbola. As noted above, the location of the receivers 128 and 130 are known.

The server 140 calculates a second hyperbola 503 (see FIG. 11) based on the eccentricity as determined from Eq. 9 and on the location of the receivers 128 and 131. The server 140 calculates a third hyperbola 505 (see FIG. 11) based on the eccentricity as determined from Eq. 9 and on the distance between the receivers 130 and 131. The server 140 (or the second receiver 130) calculates a third hyperbola 405 (see FIG. 9) based on the eccentricity as determined from Eq. 9 and on the distance between the receivers 130 and 131.

The server 140 (or the second receiver 130) determines (or locates) a location 507 which corresponds to a point in which the first hyperbola 501, the second hyperbola 503, and the third hyperbola 505 intersect. The server 140 identifies the location 507 as the location of the first transmitter 122.

### Report Protocol

In order to perform the proposed implementations as set forth in FIGS. 7-11 which incorporate utilizing time measurements as reported by receivers 128, 130, 131 to the server 140 or to one or more of the transmitters 122, 124, 126, a report protocol may be needed. For the implementations as set forth in FIGS. 7-11, there may be, for example, a total of five transmitters plus receivers. Each transmission report generated by the receiver 128, 130, 131 generally includes:
1) A unique ID of the receiver 128, 130, 131 (e.g., a 48-bit media access content (MAC) address
2) A sufficiently unique transmission ID α and a transmitter ID for a first transmitter 122, 124, 126 that transmit data to the receivers 128, 130, 131
3) A sufficiently unique transmission ID β and a transmitter ID for second transmitters 122, 124, 126 that transmit data to the receivers 128, 130, 131.
4) A local receive timestamp at high resolution, using agreed upon time units (e.g. 100 pico (10⁻¹⁰) seconds), with long unsigned integers. Time zero is arbitrary and may change at predetermined instances (e.g., when batteries are replaced at the receiver 128, 130, 131).

The server 140 may extract the transmitter ID from the transmission message (e.g., transmitter address (TA) in WiFi packets of type, Beacon, Data, RTS etc.) as provided by the receiver 128, 130, 131.

The transmission ID may be implicit such as for example, a hash of the first N bytes of data, an FCS (Frame Check Sequence) suffix as sent by the transmitter 122, 124, 126) in accordance with IEEE802.11, for example, a receive timestamp or a combination of the above. In some cases, the transmission ID may be explicit such as for example, the transmitted 64-bit timestamp (‘TSF’) in WiFi Beacons.

The above reports may be used to facilitate matching transmission pairs α, β sent by the transmitters, as measured by the multiple receivers (e.g., there may be three transmitters in addition to the receivers).

For example, the receiver 128 may report the following to the server 140:

RxID=0x00607c07049A:

TxID₁=0x0014de098743 TxID₂=0x0056e1098743 α=0x6f4e3a5e β=0xee437611 Δt=78.0769286.

The RxID in the report provides information corresponding to the reception of two packets with origins TxID₁ TxID₂ packets identified by α and β where the signals are received at Δt milliseconds apart as measured by the local clock of the receiver 128, 130, 131. Packet pairs with TxID₁=TxID₂. from the same originator (or transmitter 122, 124, or 126) may be used to measure clock drifts as noted below.

Based on the reports accumulated at the server 140 in terms time differences between particular transmissions α and β taken by receivers 128, 130, 131, the server 140 may be able to provide a hyperbola that can be drawn on the plane. This procedure may be repeated three times such that a total of three hyperbolas are provided. The intersection of the hyperbole is the location of the unknown receiver in this case (or the receiver 130 as noted above).

### Calibration to Account for Time Drift Between Receivers

Prior to determining the location of the receiver or the transmitter, it is recognized that a calibration occurs to account for a time drift between the receivers 128, 130, and 131. In reference to the receivers 128, and 130, the time differences measured by the receivers 128, 130 (e.g., Δt_{A}, Δt_{B}) are clocked locally. However, the time differences may be affected by a local drift between a corresponding local clock for the receiver 128 and for the receiver 130. For example, the clocks for the receiver 128 and the receiver 130 are not synchronized with one another and a time drift may occur between such receivers 128 and 130. In one example, the time drift may correspond to one second every hour, e.g., after one hour of the clock for the receiver 128, and the clock for the receiver 128 will be ahead of the clock for the receiver 130, by one second. The local clock drift between the receivers 128, 130 may be compensated for by using two packet transmissions α, β from a single transmitter 122 for example. Alternatively, transmitters 124 or 126 may also be used for this purpose. The two packet transmissions α, β are received by both the receivers 128 and 130. Each of the receivers 128, 130 compute the time difference between packet arrivals, which is location invariant, since both packets travel the same distance to a particular receiver 128 or 130. The receivers 128, 130 report the time distance between packet arrivals to the server 140.

The server 140 calculates the ratio

$$r = \frac{{T}_{A α} - {T}_{A β}}{{T}_{B α} - {T}_{B β}} \qquad ( eq . 10 )$$

that is used by the receiver 128 to compensate for time differences measured by the receiver 130. The server 140 calculates r⁻¹ that is used by the receiver 130 to compensate for time differences measured by the receiver 128. The server 140 provides compensated readings back to the receiver 128 and the receiver 130.

Consider the following example, if transmissions (or signals) α, β are transmitted at Δt=103.461963 msec apart from one another by transmitter 122. The time difference between these events is location independent since both travel the same path, for example, from the location of the transmitter 122 to the location of the receiver 128 and from the location of the transmitter 122 to the location of the receiver 130. Hence, ideally both receivers 128 and 130 estimate the same time difference Δt. Since both local clocks for each receiver 128, 130, respectively, have discrepancies, for example, the receivers 128, 130 may determine a Δt_{A}⁰=103.461531 and a Δt_{B}⁰=103.461229, respectively (i.e., Δt_{A}⁰ corresponds to the time difference between α, β for the receiver 128 and Δt_{B}⁰ corresponds to the time difference between α, β for the receiver 130). Therefore, when the receiver 128 receives a time report from the receiver 130 (via the server 140), the receiver 128 may correct future readings of future transmissions (from the receiver 130 as received from the server 140) of Δt_{B}¹ to its local time base based on the following:

$$Δ {t}_{B}^{1 A} = Δ {t}_{B}^{1} * \frac{103.461531}{103.461229} . \qquad ( see Eq . 10 )$$

Additionally, when the receiver 130 receives a time report from the receiver 128 (via the server 140), the receiver 130 may correct for future readings of further transmissions (from the receiver 128 as received from the server 140) based on the following;

$$Δ {t}_{A}^{1 B} = Δ {t}_{A}^{1} * \frac{103.461229}{103.461531} . \qquad ( see Eq . 11 )$$

### Time of Arrival Estimation

The receivers 128, 130 may determine the time of arrival by auto-correlating a received Long Training Field (LTF) symbol (e.g., in connection with a WiFi based signal) as received from the signals (e.g., first and second packets PCK1 and PCK2) transmitted from the transmitters 122, 124, 126. The LTF provides low side lobes and a steep main lobe in the auto-correlation function. However, adjacent symbols of the a particular LTF symbol of interest are non-zero signals which thereby affect the resultant correlation function. For example, LTFs may be transmitted with 2.5 repetitions (e.g., one half of an LTF is sent, then an LTF is sent, and then the LTF is sent again). The resultant auto-correlation comprises multiple peaks.

The free space decorrelation time of the WiFi signal may be 50 ns at a 20 MHz bandwidth. With the WiFi standard, orthogonal frequency division multiplexing (OFDM) based beacons (or packets) may be transmitted at the 20 MHz bandwidth. Typical digital receivers may process the incoming signal at 20 Ms/s (complex) for 20 MHz the channel bandwidth with a decorrelation time of 50 ns corresponding to roughly 15 m, the speed of light. In general, 52 out of the 64 frequency bins may be populated, hence the location resolution may increase to 18.5 meters.

As generally shown in FIG. 1, each transmitter 124, 126 may use a plurality of antennas 135 to transmit the packets (e.g., WiFi, beacons) and each of the transmitters 122, 124, 126 transmit the packets coherently, from the plurality of antennas as opposed to transmitting the packets from a single antenna. Space coding may be applied to overcome black spots (e.g., locations whereby destructive interference annihilates the signal). In various OFDM cases, a Cyclic Delay Diversity (CDD) may be used to transmit different versions of the same signal from the plurality of antennas 135. CDD generally applies to multiple antenna transmission schemes. A superimposed signal as received at each of the receivers 128, 130 (e.g., as received from the transmitters 122, 124, 126) may affect time estimations in different ways. For example, the auto-correlation function of the LTF comprises peaks of equal height, one per antenna element 142. The time difference between peaks amounts to a delay applied in the CDD (e.g., four 50 nsec samples) in the case of two antennas 135 that transmit WiFi based signals (e.g., beacons or packets). It is also recognized that the transmitters 122, 124, 126 may also transmit the packets (e.g., WiFi beacons) via a single antenna 135. If any of the transmitters 122, 124, 126 transmit a packet of data via a single antenna 135, then a CDD may not be applied.

### Coarse Time of Arrival Estimation

To determine the time of arrival of various signals received from the transmitters 124, 126, the receivers 128, 130 generally undergo differing detection phases to ascertain a final arrival time of the signals (or packets). In a first phase, each of the receivers 128, 130 perform a coarse time of arrival estimation by analyzing discrete peaks of the autocorrelation with the LTF symbol. For example, specific peaks of the autocorrelation are generally spaced apart at predetermined time intervals from one another, where additionally the amplitude of the peaks at such predetermined time intervals generally corresponds to the envelope of the known autocorrelation of LTF with itself. There may be three factors that create ambiguity in the form of multiple peaks in time:

(a) the linear auto-correlation of a standardized LTF may not be ideal. The ideal function may be Kronecker Delta. In general, low side lobes may be generated by even a single LTF, padded with hypothetical zeroes before and after;

(b) the LTF in the signal transmitted from the transmitters 122, 124, 126 is sent in repetition (e.g., pursuant to WiFi protocol (or IEEE802.11 for example)), thereby generating two peaks of the same strongest correlation and a few peaks of weaker correlation, 64 samples apart as set forth, for example, in the IEEE802.11 case; and

(c) the encoded signals that are transmitted from the transmitters 122, 124, 126 may create an artificial negative delay which provides a resulting peak replication at a negative offset of, for example, 200 nsec (4*50 nsec samples) as illustrated in FIG. 12 (see elements 350) in the case of two antenna legacy mode for each transmitter 122, 124, 126. CDD is generally specific to multiple antenna transmission.

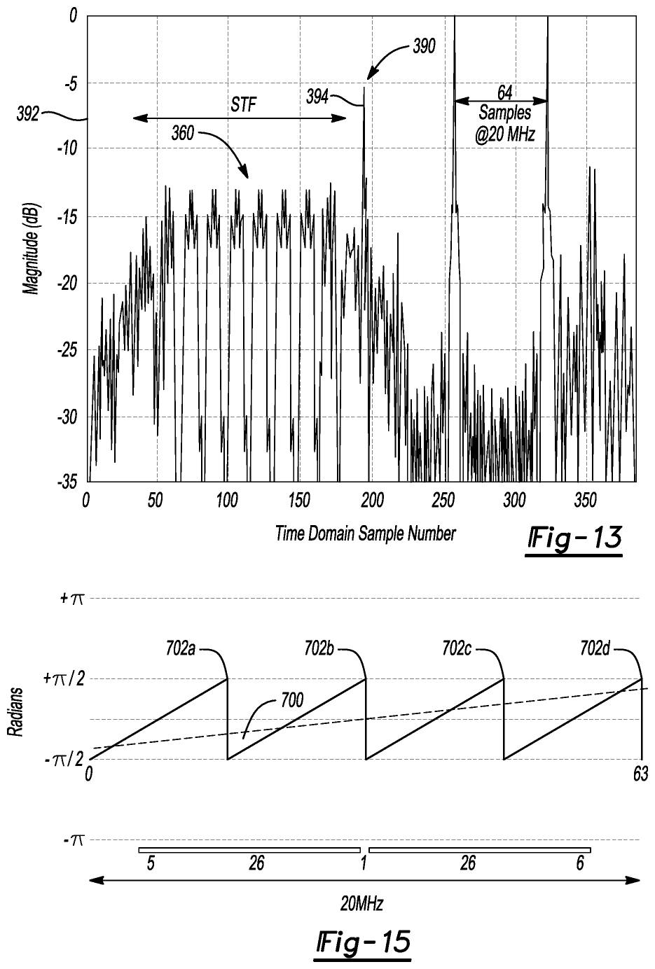

In general, each receiver 128, 130 is configured to extract the N-strongest (e.g., N=4) auto-correlation peaks within a predetermined time interval for a predetermined duration. This may start at a detected time of a Short Training Field (STF) pattern 360 in the WiFi based signal that is transmitted from the transmitters 122, 124, 126. FIG. 13 generally depicts at least one aspect related to performing the first phase detection (e.g., coarse detection) in accordance to one embodiment. FIG. 13 depicts the STF pattern for the transmitted signal from a single antenna of the transmitter 122, 124. Two transmitted signals from two antennas 135 for a corresponding transmitter 122 or 124 and the corresponding CDD is applied to separate the signals (e.g., again, see elements 350).

The desired peak pattern in a legacy LTF WiFi based signal utilizing the two antenna 135 configuration for each of the transmitters 122, 124, 126, includes each LTF symbol on the incoming signal from the transmitters 122, 124, 126 to include the strongest peaks that are separated by one another by the predetermined amount of time of, for example, T+0, T+4, T+64, or T+68 for arbitrary T. Referring back to FIG. 13, the predetermined peaks (or predetermined time intervals) of T+4 and T+68 may be specific to a multiple antennae transmission scheme (e.g., the utilization of two antennas 135 for a single transmitter 122, 124). The receivers 128, 130 as generally set forth herein may extract T under some arbitrary assumption about the added channel effects (or additional antenna affects since two antennas 135 for a particular transmitter 122, 124, 126 are utilized). For example, additive noise turn stronger than real peaks (e.g., there is no threshold and the peaks are sorted and the N strongest peaks (e.g., N=4) are selected) thereby creating a somewhat different pattern than the noise free pattern, as shown at 394 in FIG. 13. In one example, the two strongest peaks may be separated by a predetermined time interval of any one or more of the following: T+0, T+4, T+50, and/or T+68 (e.g., 64 is not strong enough and 50 is unrelated to the signal, mere additive noise). In another example, the two four strongest peaks may be separated by another predetermined time interval of any one or more of the following: T+4, T+30, T+64, and T+68 (e.g., T+0 is not strong enough and T+30 is mere additive noise). Each of FIGS. 12 and 13 generally illustrate that the two strongest peaks are separated by one another at a predetermined time interval of T+64 (or 64 samples) when only one transmitting antenna is used and no noise is present. Thus, the receiver 128, 130 selects these strongest peaks as peaks of interest for further examination based on the predetermined time interval between such peaks. In the two transmitting antennas case, the receivers 128, 130 may assume, for example, that one of the strongest four received peaks may be noise and another one of the four transmitted peaks is absent (not among the four strongest peaks). Reference is made to four transmitted peaks since each transmitter 122, 124, 126 transmits the signal via two antennas 135 per transmitter 122, 124, 126. FIG. 12 generally illustrates the two antennas 135 implementation on a given transmitter 122, 124, 126 with the CDD and FIG. 13 generally illustrates a single antenna 135 implementation on a given transmitter 122, 124, 126. The implementation in FIG. 13 is provided merely for illustrative purposes. The above provides a coarse estimation of the above epoch (time of arrival) “T”.

### Precise Time of Arrival Estimation (Discrete)

To determine the time of arrival of various signals received from the transmitters 122, 124, 126, the receivers 128, 130 generally undergo differing detection phases to ascertain a final (or precise or accurate) arrival time of the signals (or packets). As noted above, each of the receivers 128, 130 may perform a coarse time detection scheme. Each of the receivers 128, 130 may also perform a precise time detection scheme of the incoming signal after the coarse time detection scheme is performed. With the precise time detection scheme of arrival, the overall resolution increase may occur by up to, for example, two orders of magnitude, and may be achieved by interpolation. The interpolation may use convolution with samples of sinc( ) (e.g., or alternatively by zero padding the FFT of the samples) that is followed by peak selection of the complex envelope. For example, the interpolation of 32× may result in a resolution of about 58 cm. These methods may be discrete in nature, for example, padding to a quadruple the length of the data may improves the resolution by up to four times. Complexity may increase by the following (n=4 in the example):

½n log(n) (Eq. 12)

So long as a channel delay spread is smaller than 4*50=200 nseconds (about 67 meters), the two CDD peaks will not overlap. A single transmitter detector implementation (e.g., one of the receivers 128 or 130) correlates with s_{LTF}*(t), * denotes complex conjugate. The two-transmitter detector (e.g., the receiver 128 or 130) may correlate with

s_{LTF}*(t)+s_{LTF}*(t+T_{CDD}) (Eq. 13)

where * denotes a complex conjugate. Alternatively, a correlator for a single transmitter element (e.g., the transmitter 122, 124, or 126) may be applied, followed by a time window of

$$( \text{-} 100 , 50 ) ( - ∞ , \frac{{T}_{CDD}}{2} - {T}_{GI} )$$

another time window of

$$( \frac{{T}_{CDD}}{2} + {T}_{GI} , ∞ )$$

where the guard interval may be set for example to

$$\frac{{T}_{CDD}}{8} ,$$

and then averaging over the estimations, where T_{CDD} is the known delay introduced between the antennas 135. For example, in a two-antenna based legacy mode, the delay is 4*50 nsec=200 nsec and T_{G1} is a time quantity that is defined to guard against spillover between one antenna 135 to another antenna 135 as used in the selection of a window size as noted above.

In general, if the coarse peak was found at sample 215, the interval [212, 213, . . . , 219] comprising eight samples may be interpolated by 32 into 8*32=256 points in time, spaced

$$\frac{50 nsec}{32} = 1.5625 nsec .$$

The peak of the envelope may be the refined time of arrival estimate. For example, the peak is at the 143^{rd} sample out of 256. This translates into the arrival time of

$$( 215 + \frac{143 - 128}{32} ) \times 50 = 10 , 773.4375 ns .$$

The above formula originates from the following. For example, time is divided into 256 intervals of 1/32 sample each, 8 samples in total from 212 to 219 inclusive. The high-resolution estimate provides the number of 1/32 samples from start of the interval, between 0 and 255 inclusive. In the above example with respect to the 143^{rd} sample, the time estimate in nanoseconds is the coarse estimate (e.g., 215) plus the fraction 15/32 (see above

$$\frac{143 - 128}{32} )$$

translated from number of samples*50 nsec. By comparison, the coarse estimation in this example yields 215×50=10,750.0000 ns. In the example, the difference between the coarse and fine estimates translates into a displacement of 13.59 meters (58 cm per nanosecond as explained above).

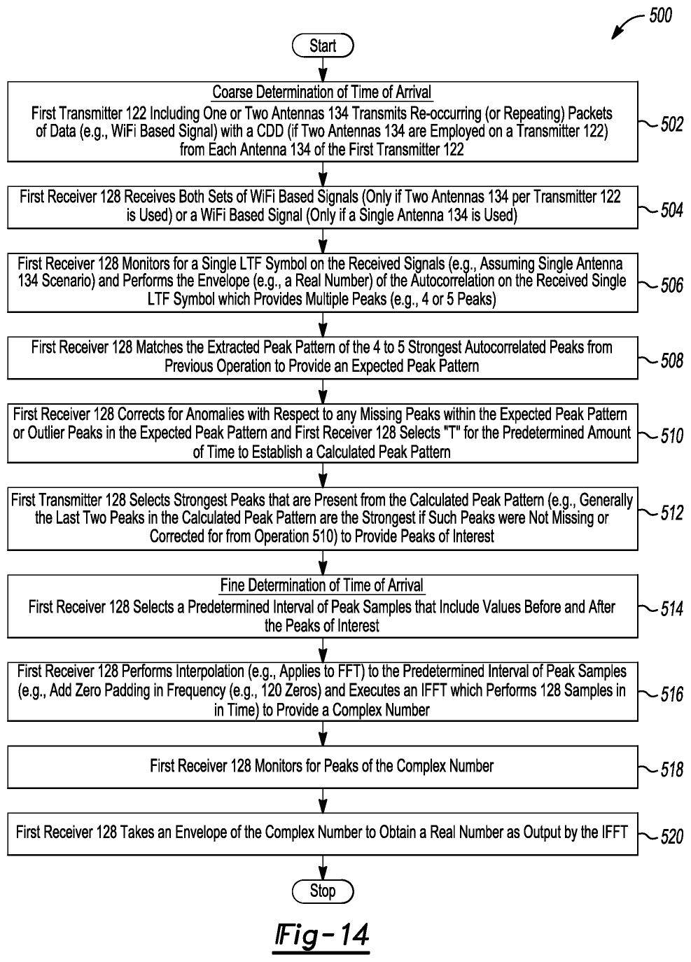

FIG. 14 depicts a method 500 for performing a coarse determination of the time of arrival (e.g., see operations 502-514) and a fine determination of the time of arrival (e.g., see operations 514-520) in accordance to one embodiment of the present invention.

In operation 502, the first transmitter 122 including one or two antennas 135 transmits re-occurring (or repeating) packets of data (e.g., WiFi based signal) with a CDD (if two antennas 135 are employed on a transmitter 122) from each antenna 135 of the first transmitter 122.

In operation 504, the first receiver 128 receives both sets of WiFi based signals (e.g., this is the case if two antennas 135 per transmitter 122 are used). If a single antenna 135 is incorporated on the first transmitter 122, then only a single WiFi based signal is received.

In operation 506, the first receiver 128 monitors for a single LTF symbol on the received signals (e.g., again assuming a single antenna 135 implementation) and performs the envelope (e.g., a real number) of the autocorrelation on the received single LTF symbol which provides multiple peaks (e.g., 4 or 5 peaks). In other words, the first receiver 128 determines the envelope autocorrelation which corresponds to the four strongest peaks of the LTF symbol.

In operation 508, the first receiver 128 matches the extracted peak pattern of the four strongest autocorrelation envelope peaks from previous operation to provide an expected peak pattern or both. Each of the peaks of the expected peak pattern, in absence of noise, may be separated by a predetermined amount of time (e.g., T+0, T+4, T+64, or T+68) for two transmitting antennas 135 of the first transmitter 122. Out of the four strongest autocorrelation peaks, it is possible that one such peak may be erroneous (unrelated to the transmitted signal) and the other may be missing altogether (e.g., excluded from the list of four strongest peaks).

In operation 510, the first receiver 128 corrects for anomalies with respect to any missing peaks within the expected peak pattern or outlier peaks in the expected peak pattern (or both). The first receiver 128 determines the time “T” for the predetermined time interval to establish a calculated peak pattern. Assuming for example, that the first receiver 128 determines that T corresponds to 70, then the calculated peak pattern is (70, 74, 134, 138). This generally corresponds to a noise free peak pattern. However, as noted above, the more likely measured peak pattern may include, for example, an erroneous value (e.g., one peak may be erroneous) and a missing value (e.g., one peak may be missing from the detected LTF symbol). For example, the expected peak pattern may be (70, 90 (an erroneous value), 134, 138). The first receiver 128 may fill in for the missing peak and discard the erroneous peak from the received peak pattern and provide (70, 74, 134, 138) as the reinforced peak pattern (or calculated peak pattern). The first receiver 128 may select the peak T+64=134 as the course peak. Again, the peak 134 is not an erroneous or missing peak, therefore such a peak is suitable for further examination and to perform additional analysis. On the other hand in the above example, T+4=74 was missing (i.e., a phantom) and cannot be used further for locating.

In operation 512, the first receiver 128 selects one or more strongest peaks that are present in the calculated peak pattern to provide one or more peaks of interest. Assuming the expected peak pattern is (70, 74, 134, 138) as noted in operation 510, the first receiver 128 selects the peaks of 134 as the peaks of interest as a result of performing the coarse determination. It bears mentioning that the first receiver 128 only selects the one or more peaks that are initially present as identified in the expected peak pattern. Because peak 134 was present, this peak will be selected. Further, the first receiver 128 is generally interested in the strongest peaks. In general, the peak pattern of 70, 74, 134, 138 may be of equal strength and those received prior to these may be considered weak (e.g., see FIG. 9 and peaks to the left of 394). The peak pattern 70, 74, 134, 138 may be considered to have noise free equal strength as a result of the one half of the LTF, as the LTF is repeated two and one half times. The pattern recognized as described above selects the N strongest peaks, ignoring the fact that weaker peaks arrive sooner. One or more of the strongest peaks generally occur later in time. If both of the strongest peaks are present as illustrated in the example provided, then the first receiver 128 may take the average timing estimates of such values. Again, the first receiver 128 will disregard a peak that is determined to be erroneous or missing as this will lead to an outlying estimation.

The fine estimation of arrival starts in operation 514. In operation 514, the first receiver 128 selects a predetermined interval of peak samples that include values before and after the peak of interest. For the peak of interest (e.g., 134); the first receiver 128 selects the interval of [131-138] for a total of 64 LTF samples (pre autocorrelation) for fine estimation processing.

In operation 516, the first receiver 128 performs interpolation (e.g., applies a Fast Fourier Transform (FFT) based interpolation) to the predetermined interval of peak samples. In this case, the first receiver 128 performs the FFT, zero pads in frequency (e.g., (16−1)*64=960 zeros) e.g., 16 fold interpolation, and performs an Inverse Fast Fourier Transform (IFFT) which results 16*64=1024 complex samples in time. The resultant LTF interpolation of 1024 samples is correlated with a 16 fold interpolated fresh (synthetic) LTF signal, LTF_{X16}, 64*16 samples long, to provide a high time resolution of the LTF autocorrelation signal, 50/16=3.125 ns per sample in the example. LTFₓ₁₆(16*k)=LTF(k), k=0, 1, 2, . . . 63, zero otherwise. In general, the higher the interpolation the better the resolution is with at the added cost of complexity. The resolution may have some physical limitations. In terms of applications, it may be preferable to aim for an interpolation of 32 or even 64 which amounts to 47 cm or 23 cm, respectively. In general, 1 nanosecond amounts to 30 cm.

In operation 520, the first receiver 128 takes the envelope of the complex number as output by the IFFT to obtain real envelop numbers. Such an output provides the two highest peaks (e.g., roughly 134 or 138) since these peaks were the strongest peaks as determined during the coarse determination. In this case, the first receiver 128 is taking the strongest peak out of 128 samples (which is provided by performing the IFFT) and that peak value corresponds to 134.25 (e.g., this is four samples after 134 (e.g., 4/16=0.25). The method 500 provides an accuracy of 1/16 of a sample and this yields an improvement. In general, such an accuracy of 1/16 of a sample amounts to 50/16*0.3m=0.94m.

### Precise Time of Arrival Estimation (Continuous)

A continuous time estimation may be achieved by estimating the linear component of phase vs frequency of the FFT of the received LTF. This generally serves an alternate embodiment to the discrete precise time of arrival described above without the need to implement the discrete coarse time of arrival. The phase slope, in the case of a single transmitting antenna 135 (or the transmitter 122 or 124 or 126), is proportional to the delay: a 2*n slope across 64 bins in the FFT amounts to exactly one samples of 50 ns. In the case of two transmitting antennas 135 for each transmitter 122, 124; the signal is more involved but may be extricated: the slope of samples taken every 16 bins may be equally proportional to the delay, thereby eliminating the effect of the CDD. Each of the 16 initial phases (or bins) may contribute to the quality of an estimator of the receivers 128, 130 that perform the precise time estimation in which all may be unbiased with one another (or that 16 estimators on average provide the same result).

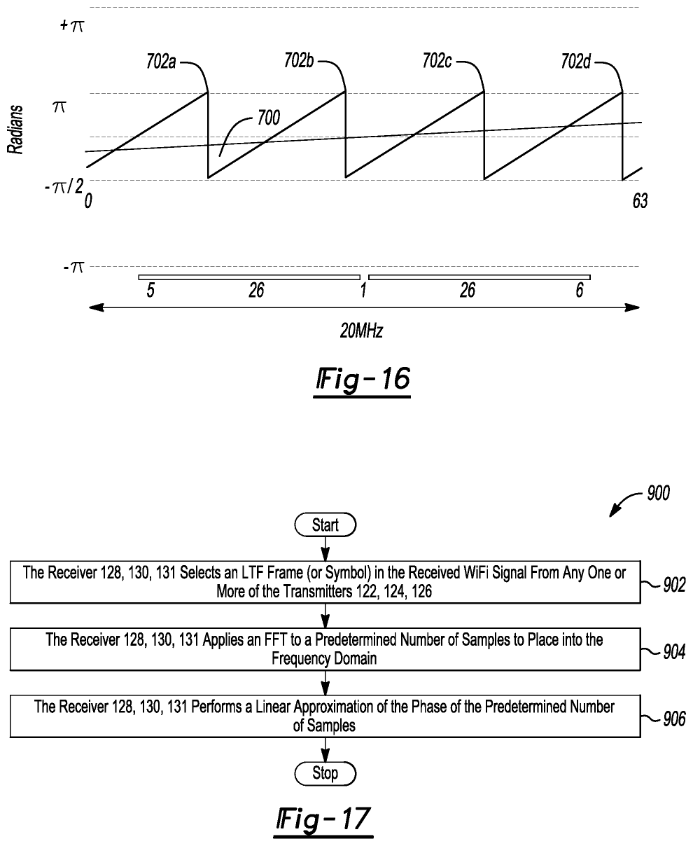

FIGS. 15 and 16 illustrate two arbitrary scenarios (e.g., time of flight (TOF) values and Direction of Departure angles) associated with the precise time detection scheme. Both of the waveforms illustrated in FIGS. 15 and 16 illustrate the TOF value and the DOD angles. It is generally not necessary to perform a coarse detection scheme prior to performing the precise time detection scheme in connection with FIGS. 15 and 16 through a crude estimation of the start of the frame is required still. Further, the slope method applied differently in the case of one transmitting antenna and two transmitting antennas. The pattern matching aspect as described above is generally equally adept at discerning between one and two transmitting antennas. In general, the TOF affects a slope 700 of the linear phase (e.g., the slope of FIG. 16 is smaller than the slope of FIG. 15). The slope of +2*π over 64 bins equals one 50 nsec sample delay. The sawtooth waveforms shift, regardless of the tilt (or slope 700) is a direct result of the Direction of Departure angles. In general, FIGS. 15 and 16 are two different DOD angles with (in this example) two different tilts (or slopes 700). The DOD affects the four frequency bins 702a-702d at which phase steps down by π radians. DOD amounts to horizontal cyclic shift in FIG. 16 relative to FIG. 15. The phase downstep+π/2->π/2 repeats itself four time in cases of a two antenna 135 implementation for each transmitter 122 or 124 that transmits WiFi packets (or beacons) including a standardized CDD delay of 4=64 bins/16 bins samples.

FIG. 17 depicts a method 900 for performing interpolation to estimate (in a continuous fashion) a fine determination of the of time of arrival of signals received at one or more of the receivers 128, 130, and 131 in accordance to one embodiment.

In operation 902, the receiver 128, 130, or 131 selects the LTF frame (or LTF symbol) in the received WiFi signal from any one or more of the transmitters 122, 124, 126. It is preferable to know where the LTF symbol starts and where the LTF symbol ends (e.g., it is defined via IEEE 802.11 with a duration for 64 samples (or 3.2 μs).

In operation 904, the receiver 128, 130, 131 applies an FFT to the 64 samples to provide 64 complex bins in the frequency domain.

In operation 906, the receiver 128, 130, 131 performs a linear approximation of the phase of the 64 complex bins to estimate the slope 700 (see FIGS. 14 and 15). With reference back to FIGS. 14 and 15, it is shown that the slope 700 takes into account 64 samples (e.g. 0 to 63) of the result obtained in response to performing the FFT. The slope 700 corresponds to a high-resolution time of arrival estimation relative to the local clock.

In particular, the slope 700 is proportional to a delay relative to receiver 128, 130, 131 in receiving the WiFi based signal from the transmitter 122, 124, 126. In general, the slope 700 is indicative of a resultant phase added to the sawtooth pattern of the received LTF symbol. The receiver 128, 130, 131 samples the LTF symbol and calculates an FFT to obtain a tilted saw tooth pattern as shown in FIGS. 14 and 15 in the case of two transmitting antennas. From there, the receiver 128, 130, 131 estimates the slope 700 by decimation of 16 at any arbitrary initial bin: there are three unknown parameters to the sawtooth pattern. The bin at which the first phase step occurs, the tilt and the offset of the phase once the sawtooth waves are subtracted. Decimation of the bins (e.g., taking bins 1, 17, 33, and 49) eliminates the saw tooth. Locating the best fit line (e.g., using the method of least squares may result the offset of the line and the slope of the line. The offset may be ignored, and the slope shall be translated into a delay relative to the local clock by multiplying the Radians per bin slope by (64/2η)*50 ns. Again, the slope 700 provides the delay relative to the time the receiver 128, 130, 131 receives the WiFi based signal using the local clock.

### Mobile Payment

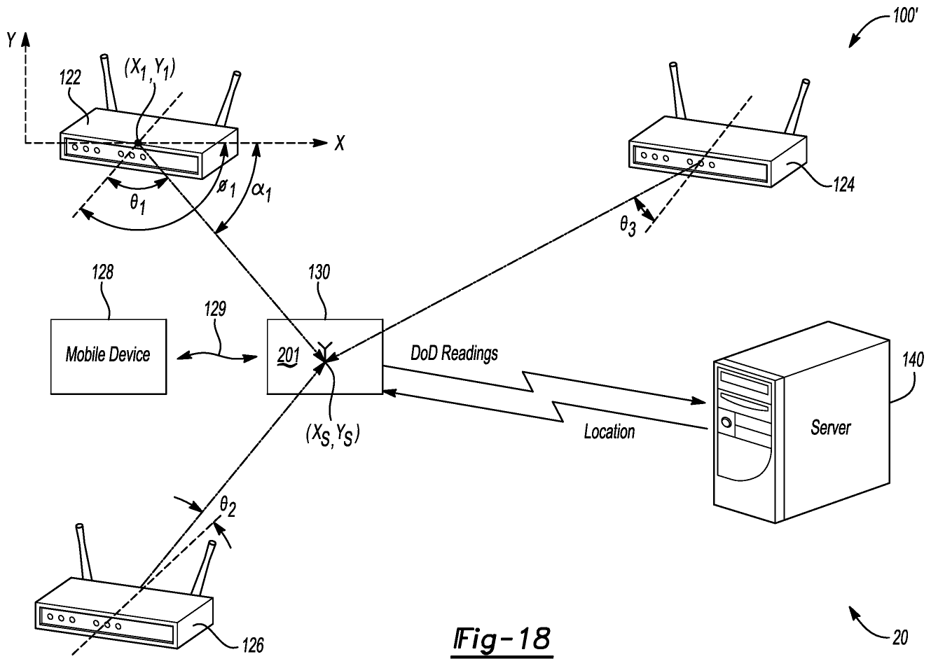

FIG. 18 generally illustrates a system 100′ that provides locationing information for a commercial transaction (e.g., mobile payment) in accordance to one embodiment. The system includes the access points 122, 124, 126, the mobile device 128, and an electronic authentication card 130 (or electronic authentication card 130) and the server 140. The electronic authentication card 130 may include an electronic circuit, such as but not limited to, the modem 201 as described above to facilitate communication with the access points 122, 124, 126. In one example, the electronic authentication card 130 may only receive information from the access points 122, 124, 126. The electronic authentication card 130 may also be configured to wirelessly communicate with the mobile device 128 via short range wireless interface 129 (e.g., Near Field Communication (NFC) or other suitable wireless protocol).

It is recognized that the electronic authentication card 130 may be implemented as a standalone device and includes locationing sensing attributes (e.g., hardware and/or software to performing or aid in determining the location of the electronic authentication card 130 as discussed above in connection with receivers) and that the electronic authentication card 130 receives information directly from the access points 122, 124, 126 and engages in bi-directional wireless communication with the mobile device 128 via the short range wireless interface 129. In another example, the mobile device 128 may include the modem 201 (or other circuitry and software) to perform or aid in determining the location of the mobile device 128 and that a simplified version of a credit card is provided that is limited to wireless communication with the mobile device 128 via the interface 129. In this case, the credit card does not receive information from the access points 122, 124, 126 and the mobile device along with the electronic authentication card 128 provides the locationing functionality. For example, the mobile device 128 and the modem 210 or other circuitry and software may be defined as the electronic authentication card 130. Additionally, the mobile device 128 and the electronic authentication card 130 may be implemented together as an integrated product or single device. It is also recognized that references to the electronic authentication card 130 as set forth herein in reference to FIG. 18, may equally apply to the location tag 131 and that the location of the location tag 131 may be ascertained via the manner as set forth in FIG. 18

A user may utilize the electronic authentication card 130 to purchase any number of items at both at indoor or outdoor retail establishments. Additionally, the electronic authentication card 130 may be used for on-line purchases, etc. Authentication and security are a concern for credit card purchases. It is desirable to increase the layers of authentication for buyers and sellers in connection with credit card purchases. In general, a difficult to spoof location of the paying device is invaluable to authentication. The questions that generally arise in a credit card purchase “is the device where it says it is” and “is the device where it is meant to be”. The locationing aspects as disclosed above may be extended to credit card transactions. The electronic authentication card 130 may benefit from the abundant population of access points 122, 124, 126 that are distributed in both indoor establishments and an external infrastructure (e.g., outside or open infrastructure) that may be in the vicinity of the electronic authentication card 130.

In one example, the location of the electronic authentication card 130 may be determined using the location-finding via CPD methodology as noted above. In this case, the electronic authentication card 130 measures the CPD from the access points 122, 124, 126. The access points 122, 124, 126 also provide their respective identifier information to the electronic authentication card 130. Again, this may be a passive operation in that the electronic authentication card 130 may not affirmatively request such information as the access points 122, 124, 126 are configured to transmit information on a rolling and constant basis. The access points 122, 124, 126 may be positioned in an external outdoor environment and/or an indoor environment. The mobile device 128 and the electronic authentication card 130 may be positioned with the user. Thus, the mobile device 128 and the electronic authentication card 130 will generally share the same proximate location as one another. To obtain the location of the electronic authentication card 130, the following may be performed. This method assumes that the respective location coordinates (labeled xᵢ,yi) and the BSSIDs of the access points 122, 124 and 126 have already been mapped by the server 140, in a frame of reference indicated by the (X,Y) axes in the figure. The map also indicates a respective orientation angle (Φᵢ) for each access point 122, 124, 126, in this case the direction of a normal to the axis of the antenna array of each access point 122, 124, 126. As noted above, the angles of departure in a two-dimensional frame of reference (assuming the access points 122, 124, 126 and the mobile device 128 and the electronic credit care 130 to be in proximity to a common plane, as explained above). Alternatively, this method may use angles of arrival measured by the access points 122, 124, 126; and it may be extended to three dimensions.

The server 140 may have previously constructed a map on the basis of measurements of angle of departure that was made previously by other mobile devices (not shown) and/or other input data. These mobile devices in this case report their locations and the estimated angles of departure to the server 140, along with respective identifiers of the access points 122, 124, 126, and the server 140 constructs the map accordingly. The server 140 may build this access point map without requiring any cooperation by operators of the access points 122, 124, 126. Alternatively or additionally, the map may incorporate information provided by network operators and/or physical measurements made using dedicated equipment.

The electronic authentication card 130 receives multi-antenna transmitted signals from each of the access points 122, 124 and 126. The electronic authentication card 130 extracts the respective angle of departure for each access point 122, 124, 126, labeled θ₁, θ₂, and θ₃ using the techniques described above, along with the respective BSSIDs (e.g., identifiers for the access points 122, 124, 126 (or 48 globally unique MAC address bits)). In addition, the access points 122, 124, 126 also transmits timestamps to the electronic authentication card 130. The electronic authentication card 130 measures the CPDs from the signals transmitted from the access points 122, 124, 126 across multiple frequency channels. In general, each of the access points 122, 124, 126 provide a wireless service on a fixed frequency channel (e.g., channel 36 with center frequency of 5180=5000+5*36 MHz). For example, access point 122 may occupy channel 36, and access points 124 and 126 may occupy channel 40. WiFi based mobile devices associate themselves and thereafter being serviced by one specific access point 122 124, 126 using the channel occupied by that access point 122, 124, 126, channel 36, channel 40, and channel 40, respectively in the above example. The mobile device is incapable of communicating on other channels since the transceiver is tuned to the particular channel the associated access point 122 for example is serving, for the duration. The use cases (i.e., Mobile Payment) or examples presented herein may be different. In general, the mobile device may not be serviced for Internet traffic by any particular access point (e.g., the access point 122 in the above example). Rather, the collective of access points 122, 124, 126 may be purposed to gather location information, spread across multiple frequency channels as allowed by the local governing authority (e.g. the Federal Communications Commission (FCC)). In a typical environment whereby N channels are allowed and M access points in the collective, on average a single channel apparatus may access M/N access points. In contrast, a multi-channel scanning apparatus may access all M access points. Typically, N may be large (e.g., even without Dynamic Frequency Selection (DFS) (802.11h) at 5 GHz. In the U.S., N=9 and even much larger with DFS).

The electronic authentication card 130 may report the CPDs along with the timestamps and identifiers for the access points 122, 124, 126, for example their BSSIDs, to the server 140, which returns corresponding location coordinates. The server 140 may determine the location coordinates of the electronic authentication card 130 and orientation angles of the access points 122, 124, 126 (e.g., (xᵢ,yᵢ, Φᵢ)) to determine the location coordinates (xₛ,yₛ) for the electronic authentication card 130. The server 140 may compare the location coordinates of the electronic authentication card 130 to determine whether the electronic authentication card 130 is positioned within a predetermined distance of the location of the wireless access points 122, 124, 126. If this condition is true, then the server 140 authorizes the purchase. If the electronic authentication card 130 is not within a predetermined distance of the access points 122, 124, 126, then the server 140 will not authorize the purchase as in this case, there may be an indication of fraud or malicious intent. These aspects will be discussed in more detail below.

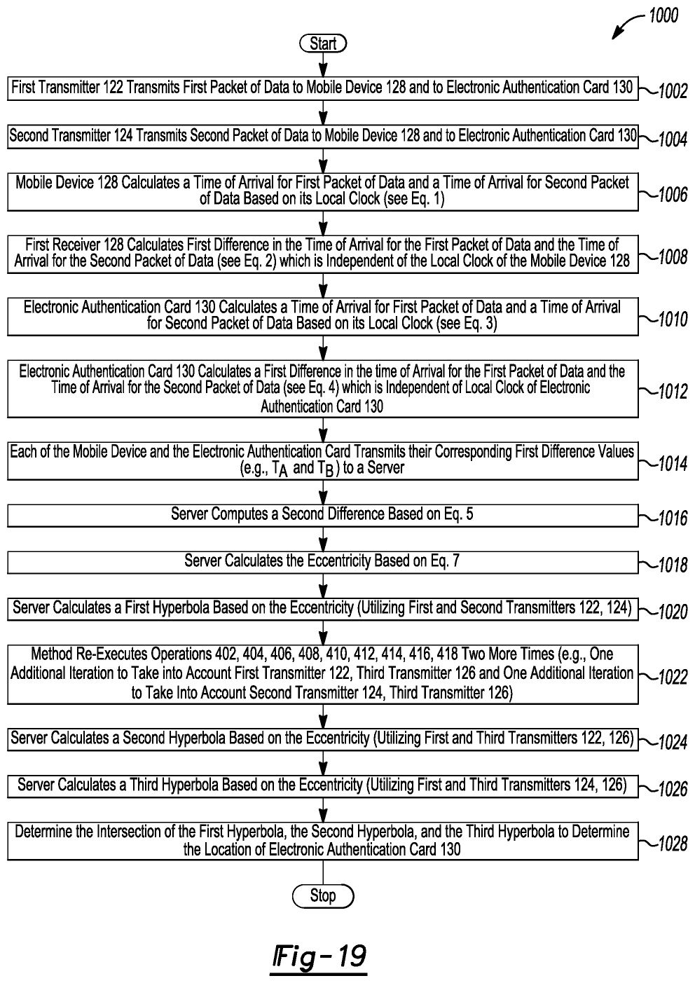

In general, the location coordinates of the electronic authentication card 130 are computed by a process of CPD-based triangulation. As noted above, each CPD measurement defines two (or more) loci in a common plane to which access points 122, 124, 126 and electronic authentication card 130 are in proximity. The loci have the form of rays extending through the plane from the respective location coordinates (xᵢ,yᵢ) of the access points 122, 124, 126, in the fixed frame of reference of the map, at angles αi, defined by Φᵢ=θᵢ+αᵢ, as given by the respective orientation angle (Φᵢ) and the measured angle of departure (θᵢ) from each of the plurality of the transmitters (or access points 122, 124, 126). The location coordinates (xₛ,yₛ) of electronic authentication card 130 correspond to an intersection of these rays, as shown in FIG. 18. It is recognized that the location of the electronic authentication card 130 may be determined based on the disclosure as set forth above in connection with FIG. 3B as an alternative to the above locationing description. For example, the mobile device 130 as set forth in connection with FIG. 3B may simply be replaced with the electronic authentication card 130. Additionally, or alternatively, it may be possible to determine the location of the electronic authentication card 130 by way of the Time of Flight methodology as set forth above in connection with FIGS. 7-11 above. This will be described in FIG. 19 below.

FIG. 19 depicts a method 1000 for determining a location of the electronic authentication card 130 through the utilization of the Time of Flight methodology in accordance to one embodiment. While the electronic authentication card 130 is referenced in connection with the method 1000, it is recognized that any receiver such as a mobile device or location tag may be used in place of the electronic authentication card such that the location for the mobile device or location tag is obtained. References to the access points 122, 124, 126, the mobile device 128, and the electronic authentication card 130 may be found in FIG. 18. The method 1000 generally employs the techniques as set forth in FIGS. 7-9 as noted above. For the method 1000, the location of the access points 122, 124, 126 (or transmitters 122, 124, 126) and the mobile device 128 is known to the server 140. For example, the respective location coordinates of the access points 122, 124 and 126 and the mobile device 128 have already been mapped by the server 140. The method 1000 utilizes the location of the transmitters 122, 124, 126 and the receiver 128 to determine the location of the receiver 130.

For operations 1002, 1004, 1006, 1008, 1010, 1012, 1014, 1016, and 1018, the method 1000 utilizes location information for the two transmitters 122, 124 and the mobile device 128 to determine a first hyperbola. The foregoing noted operations 1002, 1004, 1006, 1008, 1010, 1012, 1014, 1016 are re-executed two more times to take into account location information for the following transmitter pairs: 122, 126 and 124, 126 with the same receiver 128.

In operation 1002, the first transmitter 122 transmits a first packet of data (e.g., a WiFi based signal) to the mobile device 128 and to the electronic authentication card 130.

In operation 1004, the second transmitter 124 transmits a second packet of data (e.g., a WiFi based signal) to the mobile device 128 and to the electronic authentication card 130.

In operation 1006, the mobile device 128 calculates a time of arrival for the first packet of data and a time of arrival for the second packet of data based on its local clock (see Eq. 1 above).

In operation 1008, the mobile device 128 calculates the first difference in the time of arrival for the first packet of data and the time of arrival for the second packet of data (see Eq. 2) which is independent of the local clock of the mobile device 128.

In operation 1010, the electronic authentication card 130 calculates a time of arrival for the first packet of data and a time of arrival for the second packet of data based on its local clock (see Eq. 3 above).

In operation 1012, the electronic authentication card 130 calculates the first difference in the time of arrival for the first packet of data and the time of arrival for the second packet of data (see Eq. 4) which is independent of the local clock of the electronic authentication card 130.

In operation 1014, each of the mobile device 128 and the electronic authentication card 130 transmits their corresponding first difference values to the server 140. It is recognized that the first receiver 128 may alternatively transmit its corresponding first difference value to the electronic authentication card 130.

In operation 1016, the server 140 (or the electronic authentication card 130) computes a second difference based on Eq. 5.

In operation 1018, the server 140 (or the electronic authentication card 130) calculates the eccentricity based on Eq. 7.

In operation 1020, the server 140 (or the second receiver 130) calculates a first hyperbola (e.g., see FIG. 9, element 401) based on the eccentricity as determined in operation 1018 and on the location of the transmitters 122, 124, the loci of the hyperbola. In general, to determine the first hyperbola, the eccentricity needs to be known in addition to the location (loci) of the transmitters 122 and 124. As noted above, the location of the transmitters 122 and 124 are known. Therefore, it is possible to determine the loci and the distance between the transmitters 122 and 124 and calculate eccentricity e.

In operation 1022, the method 1000 re-executes operations 1002, 1004, 1006, 1008, 1010, 1012, 1014, 1016, and 1018 two more times. As noted above, the first time that method 1000 was executed, information corresponding to the location of the transmitters 122, 124 was utilized. However, it is necessary to investigate all of the transmitter pairs to determine the location of the electronic authentication card 130. Thus, the second time operations 1002, 1004, 1006, 1008, 1010, 1012, 1014, 1016, and 1018 are executed, information corresponding to the location of the transmitters 122 and 126 are employed. Further the third time operations 1002, 1004, 1006, 1008, 1010, 1012, 1014, 1016, and 1018 are executed, information corresponds to the location of transmitters 124 and 126 are employed.

In operation 1024, the server 140 (or the electronic authentication card 130) calculates a second hyperbola (e.g., see FIG. 9, element 403) based on the eccentricity as determined in operation 1018 and on the distance between the transmitters 122 and 126.

In operation 1026, the server 140 (or the electronic authentication card 130) calculates a third hyperbola (e.g., see FIG. 9, element 405) based on the eccentricity as determined in operation 1018 and on the distance between the transmitters 124 and 126.

In operation 1028, the server 140 (or the electronic authentication card 130) determines (or locates) a location 407 which corresponds to a point (or intersection) in which the first hyperbola 401, the second hyperbola 403, and the third hyperbola 405 intersect. The server 140 identifies the location 407 as the location for the electronic authentication card 130. It is further recognized that the mobile device 128 may be utilized as the receiver 128 and that the electronic authentication card 130 may be utilized as the receiver 130 as identified in sections as above as the: (i) Report Protocol, (ii) Calibration to Account for Time Drift Between Receivers, (iii) Autocorrelation (e.g., Coarse Time of Arrival Estimation and Precise Time of Arrival Estimation (Discrete)), and/or Precise Time of Arrival Estimation (Continuous). It is also recognized that any of the applications noted herein are capable of employing TOF to determine the location of the corresponding received that is employed. Further, any of the applications may also use any one or more of the technologies (or embodiments) as disclosed in the above foregoing sections.

The server 140 transmits the location coordinates to the electronic authentication card 130 unless the electronic authentication card 130 determines the location coordinates itself. The server 140 may compare the location coordinates of the electronic authentication card 130 to determine whether the electronic authentication card 130 is positioned in reference to the location of the wireless access points 122, 124, 126. If this condition is true, then the server 140 authorizes the purchase. If the electronic authentication card 130 is not within a predetermined distance of the access points 122, 124, 126, then the server 140 will not authorize the purchase as in this case, there may be an indication of fraud or malicious intent. These aspects will be discussed in more detail below. The location determination aspects as noted herein in connection with the electronic authentication card 130 increases security and prevents credit card misuse. Further, the locationing aspects noted herein in connection with the electronic authentication card 130 improves the overall technology since the locationing aspects do not depend on GPS coordinates for determining the location of the electronic authentication card 130 particularly for indoor based purchases where obtaining such GPS information may be subject to highly inaccurate location readings. Furthermore, there is no need for the electronic authentication card 130 to actively transmit to the access points 122, 124, 126 and hence there is no association required with the access points 122, 124, 126 as the electronic authentication card 130 may be passive and simply receive data from the access points 122, 124, 126. Passive authentication may be more effective much like covert police detective work.

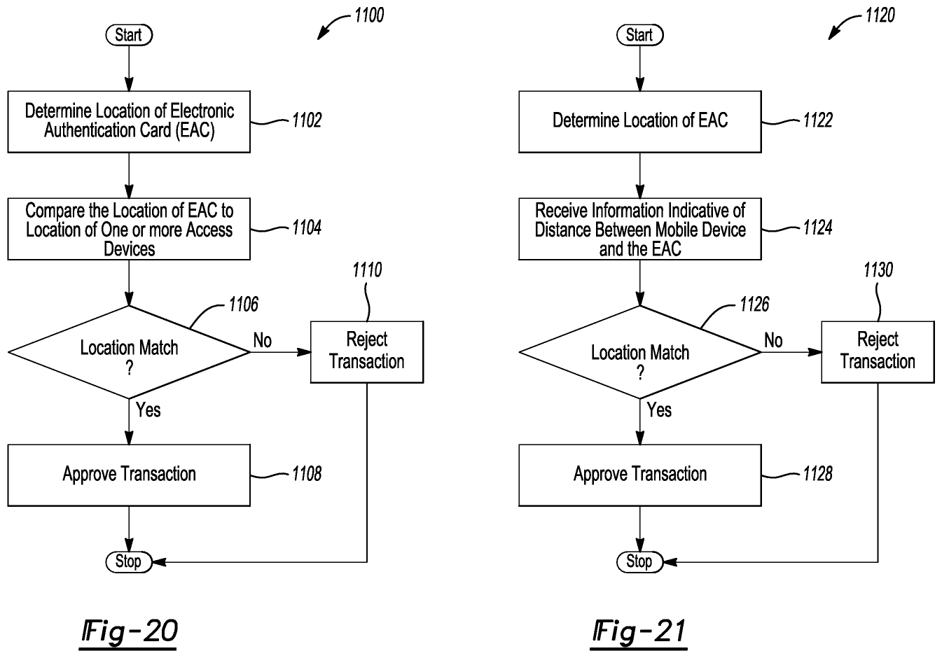

FIG. 20 depicts a first method 1100 for corroborating a purchase via the electronic authentication card 130 in accordance to one embodiment.

In operation 1102, the server 140 determines the location of the electronic authentication card 130 as noted in the manner discussed in connection with FIGS. 18 and 19.

In operation 1104, the server 140 compares location coordinates of the electronic authentication card 130 to the location coordinates of the access devices 122, 124, 126 that are known to be in the area. As noted above, the server 1102 has knowledge of the location of such location devices 122, 124, 126.

In operation 1106, the server 140 determines whether the location coordinates of the electronic authentication card 130 support a legal transaction or exclusively renders the transaction fraudulent. For example, the electronic authentication card 130 should be near reasonable location that is considered to be proximate to the seller's establishment (i.e., if purchasing an item from a seller at a store/commercial place of business). If this condition is true, then the method 1100 proceeds to operation 1108. If not, then the method 1100 proceeds to operation 1110. Typically, the server 140 requires the location estimation for the electronic authentication card 130 to fall inside a pre-designated area (e.g., circle, etc.) around a nominal position. In one example, the nominal position may correspond to a position in front of the cashier/cash register. In other words, the estimated position (x, y) should comply with (x−x₀)²+(y−y₀)²<R² for a nominal location (x₀, y₀) and a reasonable radius R (e.g., 3 feet) for the server 140 to approve the transaction. It is recognized that server 140 may employ a learning process where prior valid authorizations construct and store a set of (x, y) locations to establish the pre-designated areas that are considered locations in which transaction may be authorized when the electronic authentication card 130 is within these areas.

In operation 1108, the server 140 approves the transaction or purchase since the location coordinates of the electronic authentication card 130 are found to support a legal transaction or exclusively renders the transaction fraudulent. This condition confirms that the electronic authentication card 130 is in the location that it says it is within since the location coordinates of the electronic authentication card 130 and the access points 122, 124, 126 coincide with one another. The server 140 then alerts the merchant and the merchant alerts the card owner to slide (or swipe) their simplified card to perform the purchase.

In operation 1110, the server 140 rejects the transaction and will not proceed since the locations coordinates of the electronic authentication card 130 indicate that the electronic authentication card 130 is not at the same location of the access points 122, 124, 126.

FIG. 21 depicts a second method 1120 for corroborating a purchase via the electronic authentication card 130 in accordance to one embodiment.

In operation 1122, the server 140 determines the location of the electronic authentication card 130 as noted in the manner discussed in connection with FIGS. 18 and 19.

In operation 1124, the server 140 receives information indicative of proximity between the mobile device 128 and the electronic authentication card 130. The mobile device 128 and the electronic authentication card 130 are operably coupled with another via the short-range wireless interface 129 such a via NFC. Thus, in the event the electronic authentication card 130 detects the presence of the mobile device 128, the electronic authentication card 130 transmits a signal indicative of the presence of the mobile device 128 to the server 140. If the mobile device 128 includes the electronic authentication card 130 with the locationing functionality, the electronic authentication card 130 may still communicate with the simplified version of the credit card via the link 129. In this case, the simplified version the credit card cannot communicate with the server 140. Upon detecting the simplified version of the credit card, the electronic authentication card 130 transmits a signal indicative of the presence of the simplified version of the credit card.

In operation 1226, the server 140 determines whether the mobile device 128 and the electronic authentication card 130 are in proximity of each (e.g., this condition applies when both devices are separate from one another). The server 140 determines whether the mobile device 128 and the electronic authentication card 130 are in proximity with the simplified credit card (e.g., this condition applies when the mobile device 128 and the electronic authentication card 130 are integrated together). If this condition is true, then the method 1120 moves to operation 1128. If not, then the method 1120 moves to operation 130.

In operation 1228, the server 140 approves the transaction or purchase since the location coordinates of the electronic authentication card 130 are found to be within the predetermined distance of the mobile device 128. Alternatively, the server 140 approves the transaction since the electronic authentication card 130 is within the predetermined distance of the simplified credit card. This condition confirms that the electronic authentication card 130 is in the location that it says it is since the location coordinates of the electronic authentication card 130 and the access points 122, 124, 126 coincide with one another. If the mobile device 128 includes the electronic authentication card 130 with the locationing functionality, the mobile device 128 may alert the user to slide their simplified card to perform the purchase after the server 140 approves the transaction. This corroboration that the user is an authorized to perform the purchase since the electronic authentication card 130 is in proximity with the mobile device 128 which is known to be owned or carried by an authorized buyer. This may also be in the simplified credit card example as the electronic authentication card 130 is known to be proximate to the simplified credit card.

In operation 1130, the server 140 rejects the transaction and will not proceed since the electronic authentication card 130 is not proximate to the mobile device 128 or the simplified credit card.

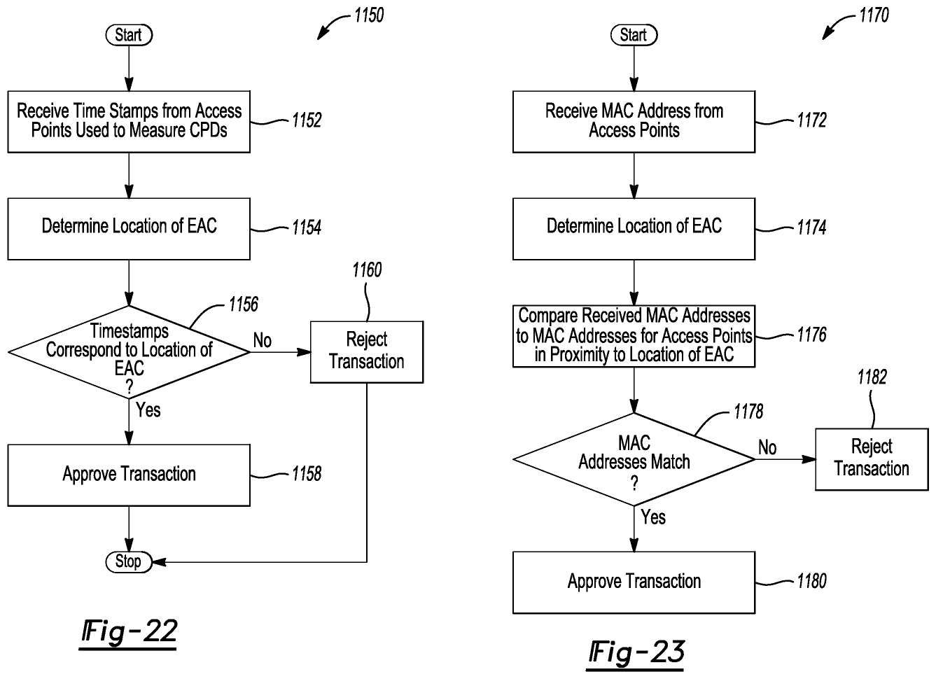

FIG. 22 depicts a third method 1150 for corroborating a purchase via the electronic authentication card 130 in accordance to one embodiment.

In operation 1152, the server 140 receives timestamps and CPDs from the electronic authentication card 130 and transmits the same to the server 140. As noted above, the timestamps and CPDs are transmitted from the access points 122, 124, 126.

In operation 1154, the server 140 determines the location of the electronic authentication card 130 as noted in the manner discussed in connection with FIGS. 18 and 19.

In operation 1156, the server 140 determines whether the timestamps as transmitted from the access points 122, 124, 126 actually correspond to the location of the electronic authentication card 130. In general, the timestamps correspond to the number of microseconds that has elapsed since their individual last reboot at the access point 122, 124, 126. The timestamps are layer II data that does not escape or leak into the Internet, a layer III (AP) network. In a way, the fact that the electronic authentication card 130 of the timestamps that are broadcast by a number of access points 122, 124, 126 serves as “evidence” of their presence of their location. The inherent drift in the timestamp of about 100 PPM makes this more difficult to spoof (or manipulate for purposes of misuse the electronic authentication card 130). The evidence is “corroborated” by many independent “eyewitnesses”, individual 122, 124, 126. In addition, in the event the electronic authentication device 130 reports a timestamp that reports the presence of an access point 122, 124, 126 that the server 140 knows is not in proximity of the electronic authentication device 130. The timestamps themselves server as an identifier for the access points 122, 124, 126 are either known to be in proximity (or within the predetermined distance) of the electronic authentication device 130 or known not to be in proximity (or out of the predetermined distance) of the electronic authentication device 130. If this condition is true, then the method 1150 moves to operation 1158. If not, then the method 1150 moves to operation 1160.

In operation 1158, the server 140 approves the transaction.

In operation 1160, the server 140 rejects the transaction.

FIG. 23 depicts a fourth method 1170 for corroborating a purchase via the electronic authentication card 130 in accordance to one embodiment.

In operation 1172, the server 140 receives MAC addresses (e.g., identifier information) from electronic authentication device 130 that are received from the access devices 122, 124, 126.

In operation 1174, the server 140 determines the location of the electronic authentication card 130 as noted in the manner discussed in connection with FIGS. 18 and 19.

In operation 1176, the server 140 compares the received MAC addresses to previously stored MAC addresses for the access points 122, 124, 126. The server 140 has previous knowledge of the location of the access points 122, 124, 126 and therefore has previous knowledge of their corresponding MAC addresses for the access points 122, 124, 126.

In operation 1178, the server 140 determines whether any one or more of the received MAC addresses match one or more of the previously stored MAC addresses that are stored in the server 140. In general, the information received by the electronic authentication card 130 (via the access points 122, 124, 126) survives readings from a subset of the active access point set. It may not be necessary for all of the MAC addresses from all of the available access points 122, 124, 126 to be compared to the previously stored MAC addresses as a number of the access points 122, 124, 126 may be temporarily out of service. In one example, there may be a minimum of three MAC addresses for the three access points 122, 124, 126 that may match three sets of previously stored MAC addresses to authenticate the transaction. In the above noted example, the electronic authentication card 130 (or the server 140) may be programmed to elicit flexibility based on the over amount of the transaction and whether the minimum number of MAC addresses have been verified. For example, the transmission may approve a single transaction of up to $100 within the next 24 hours if a smaller number of MAC addresses that are below the minimum match some of the previously stored MAC addresses. However, in this instance the electronic authentication card 130 (or the server 130) may reject the transaction if the transaction amount is larger than a predetermined value or monetary amount. For larger transactions, strict adhesion to the a minimum number of MAC addresses must match the previously stored MAC addresses. Thus, if the condition of operation 1178 is true, then the method 1170 moves to operation 1180. If this condition is false, then the method 1170 moves to operation 1182.

In operation 1180, the server 140 approves the transaction or purchase since the received MAC addresses as provided by the electronic authentication card 130, which is in proximity to the access points 122, 124, 126, match one more of the previously stored MAC address in the server 140. This condition increases the level of authentication between the electronic authentication card 130 and the server 140. If the mobile device 128 includes the electronic authentication card 130 with the locationing functionality, the mobile device 128 may alert the user to slide their simplified card to perform the purchase after the server 140 approves the transaction.

### Chain of Custody

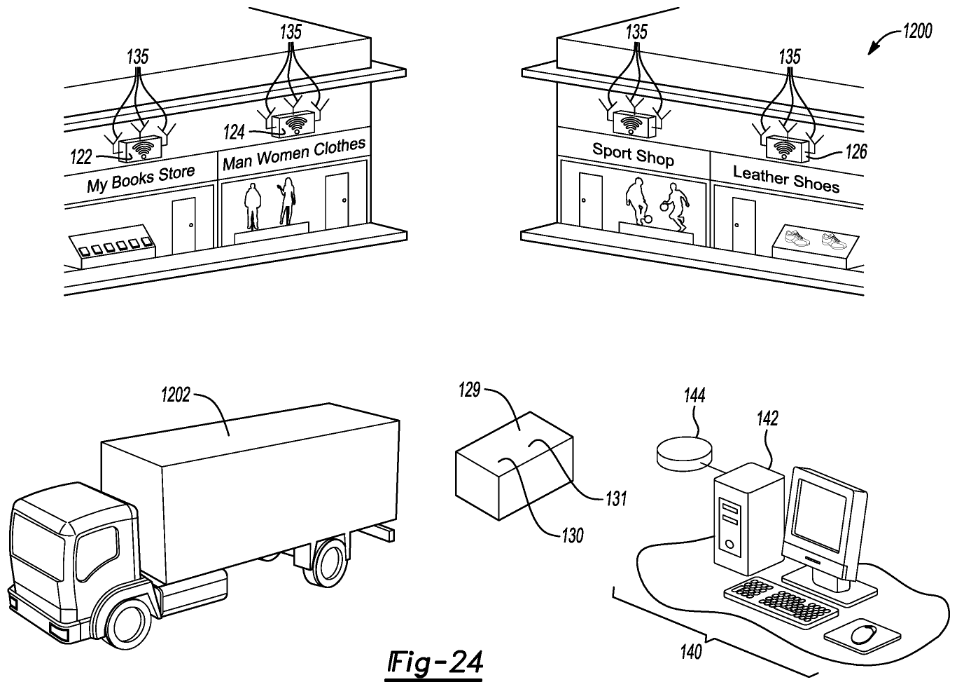

FIG. 24 depicts a system 1200 for monitoring an object 129 based on locationing information of a mobile device 130 in accordance to one embodiment. As noted above, the mobile device 130 may correspond to cellular phone or other sorts of mobile transceivers, such as laptop, tablets computers, wearable electronic devices (e.g., smart watches). As also noted above, the mobile device 128 may also correspond to a location tag 131 that includes a wireless transceiver and other electronic circuitry (e.g., a processor) that is arranged for attachment to the object 129. The location tag 131 is generally situated to perform location sensing in accordance to the embodiments as disclosed herein and provide information indicative of its location to the server 140. The system 1200 may be arranged to monitor the overall transit of the object 129 as carried by a carrier 1202. FIG. 24 illustrates that the carrier 1202 is a delivery truck, however, it is recognized that the carrier 1202 may correspond to a user (or person), a boat, airplane, or any other mechanism that may move the object 129 from one point to another. Overall, the system 1200 is configured to tightly monitor the transit of the location tag 131 to ensure that chain of custody of the object 129 has not been broken. It is recognized that a user within the carrier 1202 or the carrier 1202 itself includes the mobile device 128 such that the TOF implementation as noted above may be used to enable the server 140 to determine the location of the location tag 131.

Some applications may require providing location information which provides a tight enough space-time net, out of which the asset (or object 129) would unlikely escape from unintentionally or unnoticed. With current systems, the object 129 reports its location at arbitrary points in time beyond the control of the device or periodically so given a physical limit on the speed at which the device may traverse e.g. terrestrially. Further, the ubiquity of the solution given is that there are 3^{rd} party access points literally everywhere people live and the asset's ability to escape the net in space, rather than in time, without being recaptured, is very limited. Tightening the net (or tightening the monitoring) is also possible, by deploying access points 122, 124, 126 which serves a dual purpose: providing data network access and location at the same time. Given the unique nature of the locationing capabilities as disclosed herein, it is possible to monitor for the location of the object 129 via the passive location tag 131 (or mobile device 130) that is attached to the object 129 through information from the unmodified access points 122, 124, 126. The location tag 131 (or any other mobile device 130) may be embedded into an object 129 (e.g., in the form of a hand or ankle chain bracelet, a collar, concealed in a vehicle etc.) to provide status with respect to its location. The location tag 131 may require a wide area backhaul connection such as LTE, that is used for making location reports. The location tag 131 may report its location upon request from the server 140 over a back-haul link. The location tag 131 may also prompt reports periodically, when being moved, when its location is certain.

The server 140 may construct a chain of custody (or lack thereof) given locations and timestamps of any and all individual devices. If the server 140 determines that too much time has elapsed since the location tag 131 provided information corresponding to its location, then the server 140 may determine that the chain of custody has been broken. Further, if the location is known to be out of a predetermined perimeter or area (e.g., the location tag 131 is not meant to be located where it is reported), then the chain is broken. If the apparent speed of the location tag 131 is too high by the carrier 1202 (e.g., the distance the location tag 131 traveled, divided by elapsed time, of any two points in space-time), then the chain is broken. If the location estimated by subsets of access points 122, 124, 126 is inconsistent, then the chain is broken.

This technology may be particularly useful for any number of industries. In one example, pharmaceutical companies may intend to closely monitor the transmit any number of drugs, prescriptions, vaccines, etc. to ensure that these materials are shipped to the intended party to prevent misuse or abuse. The server 140 may provide real time information with respect to the locations of the drugs, vaccines to electronic servers belonging to these companies to ensure that these items have been under custody of the party that was hired to deliver the items. The server 140 is capable of generating detailed reports with respect to location, time at location, deviations from intended routes, and number of occasions in which the chain of custody has been broken. This application can apply to any industry that has an interest in ensuring that a product/object 129 remains with a designated person while in transmit from one location to another. The locationing sensing aspects performed by the location tag 131 need not rely on GPS coordinates and simply relies on the passive receipt of wireless transmissions from the access points 122, 124, 126. The reliance on GPS coordinates may not be optimal for indoor monitoring.

It is further recognized that cities, states or other municipalities may use the location tags 131 to monitor the transport of prisoners. Additionally, parents may load applications on their respective mobile devices to monitor the physical location of teenagers or younger children. Thus, in this instance, the system 1120 may perform various geo-tracking related functionality. For example, teenagers or other individuals may include mobile devices that include the locationing sensing characteristics as noted herein which communicate with the server 140 to provide the location of the teen or child via the mobile device.

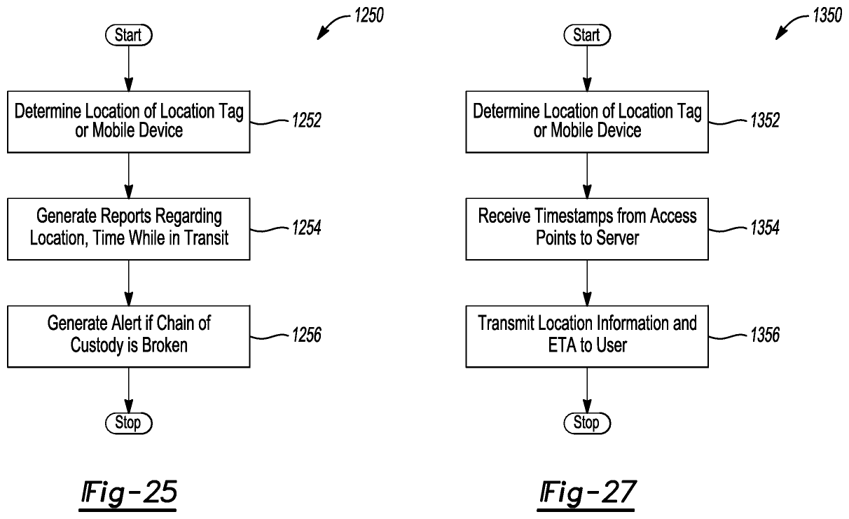

FIG. 25 depicts a method 1250 for monitoring the object 129 based on locationing information to perform a chain of custody examination in accordance to one embodiment.

In operation 1252, the server 140 determines the location of the location tag 131 (or the mobile device 130, or any if applicable) as noted in the manner discussed in connection with FIGS. 18 and 19. It is recognized that the server 140 inherently determines the location of the object 129 since the location tag 131 is coupled to the object 129.

In operation 1254, the server 140 generates reports in real time that includes information corresponding to the location and time while in transmit or while the object 129 is being monitored. It is recognized that the server 140 may transmit basic information such as the location data and timestamp information (e.g., location vs. timestamp) to an external server (not shown) that may be under control of a third party that is interested in monitoring the chain of custody of the object 129. As noted above, the timestamps may be transmitted from the access points 122, 124, 126 to the location tag 131 and onto the server 140.

In operation 1256, the server 140 generates an alert if the chain of custody has been broken. The chain of custody of the object 129 may have been broken if any one or more of the following have been detected: too much time has elapsed since the location tag 131 provided information corresponding to its location, the detected location is known to be out of a predetermined perimeter or area (e.g., the location tag 131 is not meant to be located where it is reported), the apparent speed of the location tag 131 is too high by the carrier 1202 (e.g., the distance the location tag 131 traveled, divided by elapsed time, of any two points in space-time), then the chain is broken, and/or location estimated by subsets of access points 122, 124, 126 is inconsistent, then the chain is broken. In this instance, the server 140 may transmit an alert to a mobile device or server that monitors the chain of custody of the object 129.

### Parcel Management

Referring back to FIG. 24, the system 1200 may alternatively be utilized to determine the location of a parcel. It is recognized that the parcel may correspond to any package or enclosed volume that stores an item or good that is purchased by a user. The object 129 may be viewed as a parcel. The parcel 130 may include the location tag 131 which performs locationing sensing as noted above under the Chain of Custody scenario above. Given the passive nature of the solution (e.g., location tag 131 passively receive information from the access points 122, 124, 126) and the employment of almost ubiquitous access point 122, 124, 126 coverage for network access, the locationing solutions as disclose herein becomes a viable asset management vehicle for parcels traveling great distances in public areas, areas under different justifications, with accuracy that may good enough to reach individual parcels within less than one feet amongst many parcels, let alone locate the room or compartment the parcel is at, prior to reaching the desired location. Additionally, it is possible to advise the right person about the location of the parcel in space-time via the server 140. As noted above, the location tag 131 includes a power supply, a wireless receiver, a backhaul component such as LTE transceiver, a battery and an array of antennas. The location tag 131 may be embedded into a potentially non reusable container (or parcel 130) of the goods shipped, equipped with sufficient energy for the journey, and an antenna array that may survive arbitrary parcel orientations (e.g., parcel upside down, sideways, next to walls etc.). The location tag 131 may be reused. The recipient may opt to sell the location tag 131 like a recycled bottle, sharing the profit with the sender in return for a virtual key the sender will provide to the recipient.

### Vehicle Ride Share Locationing/Rendezvous

FIG. 26 depicts a system 1300 for directing a vehicle 1302 to a user 132 based on locationing information in accordance to one embodiment. The vehicle 1302 may be owned and operated by a ride sharing entity. The vehicle 1302 may include one or more location tags 131 positioned thereon. As discussed earlier, the location tag 131 provides location information about the vehicle based on passively received signals from the access points 122, 124, 126. The location of the vehicle 1302 is inferred (or determined) by the location tag 131 (or mobile device 130) that is attached to the object 129 through information from the unmodified access points 122, 124, 126. Additionally, or alternatively, the location tag 131 cooperates with a mobile device 128 belonging to a future passenger (or customer of the ride share service) of the vehicle 1302 in addition with the access points 122, 124, 126 to provide locationing information to the server 140 based on the TOF implementation as set forth above and in connection with FIG. 19.

The location tag 131 transmits the locationing information along with timestamps received by the access points 122, 124, 126 to the server 140. The server 140 transmits information corresponding to the location of the vehicle 1302 in addition to the expected time of arrival (e.g., based on the timestamp information) to an application (“app”) executed on the future passenger's 132 mobile device 128 over a communication link 139. It bears mentioning that the location of the future passenger 132 may be determined. For example, the future passenger's 132 mobile device 128 may also facilitate locationing sensing by sending broadcast WiFi packets from the mobile device 128 so that the location tag 131 and other tags can apply the “locate the transmitter” aspect as disclosed above. In this case, the server 140 determines the location of the future passenger 132 using three or more receivers at known locations, one of which is likely onboard the vehicle 132 which may pertain to a driver (e.g., a receiver (or mobile phone) of employee of the ride share service or existing passenger(s) who are currently in the vehicle 1302 that have a mobile device that may be dropped off prior to picking up the future passenger 132). The server 140 may then provide location information of the passenger 132 to the driver of the vehicle 1302 (e.g., employee of the ride-share service) and the passenger 132 from the server 140 via mobile device 128 of the passenger 128. With the locationing sensing provided by the location tag 131, improved accuracy may be achieved over the location resolution offered by GPS coordinates. Additionally, the server 140 is configured to remotely determine whether a rendezvous has been made between the vehicle 1302 and the passenger 132 and further, when the rendezvous actually occurred.

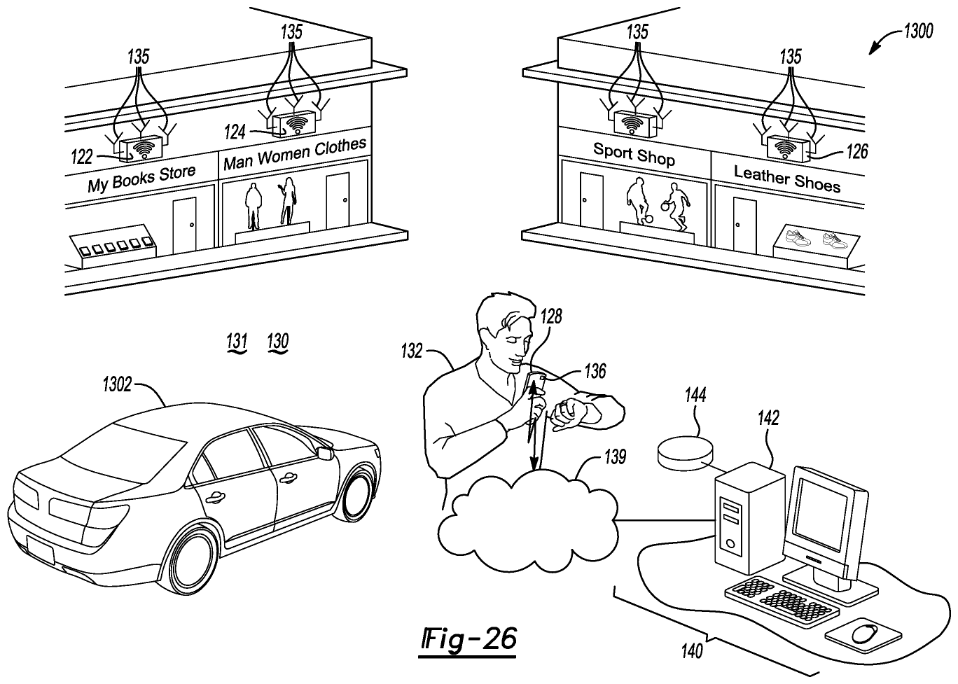

FIG. 27 depicts a method 1350 for directing a vehicle 1302 to a user 132 based on locationing information in accordance to one embodiment.

In operation 1352, the server 140 determines the location of the location tag 131 (or the mobile device 130, or any if applicable) (i.e., determines the location of the vehicle 1302) as noted in the manner discussed in connection with FIGS. 18 and 19.

In operation 1354, the server 140 receives timestamps from the access points 122, 124, 126 via the location tag 131 along the location information while performing the locationing sensing and prior to the server 140 determining the location of the location tag 131.

In operation 1356, the server 140 transmits the location of the vehicle 1302 along with an estimated time of arrival with respect to when the vehicle 1302 will rendezvous with the user 132.

In general, one or more of the various applications as noted above (e.g., mobile payment, chain of custody, parcel management, vehicle ride share/rendezvous) may require an extension of a local area solution to a global extension with potential black holes (e.g., no service) in space and time. Hence, a global coordinate system may be employed such as for example, the World Geodetic System (WGS84) to support these applications. The known locations of the access points 122, 124, 126 and estimated locations of the receivers 128, 130 and the transmitters (e.g., 122, 124, 126, 128, and 130) may incorporate aspects related to the WGS84.

Aspects disclosed herein generally provide for an expanding single, infrastructure free, local cell solutions (e.g., location determination utilizing CPD and ToF) into a global solution whereby the uniqueness of BSSIDs across the globe and the real time connectivity between the mobile device(s) and, for example, a single global server facilitate a global, reliable (e.g. difficult to spoof or workaround from a security perspective) real-time location technology with particular applications that are infeasible without such a global real-time solution. The locationing aspects as disclosed herein improve existing implementations for the various applications as noted herein. For example, there is no longer a reliance on GPS coordinates to provide locationing functionality for credit card, object tracking (e.g., chain of custody, parcel monitoring, etc.), vehicle ride share rendezvous, etc. Each of these applications may benefit from the disclosed wireless locationing solutions that employ CDPs and TOF while interfacing with a server. Additionally, each of these applications may realize an increase in the overall resolution of location estimation for an object with provides reliable results and increased levels of security that may not be achieved with existing implementations.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system for enabling an electronic transaction for a purchase based on wireless communication, the system comprising:
at least one transceiver; and
an electronic authentication card including the at least one transceiver to initiate a purchase for a user and being programmed to:
wirelessly receive a plurality of wireless signals from at least one transmitter;
process the plurality of wireless signals to generate first information indicative of a location of the electronic authentication card,
wirelessly transmit the first information to a server; and
wirelessly receive location coordinates from the server identifying the location of the electronic authentication card based on the first information.

2. The system of claim 1, wherein the server is programmed to store a location of the at least one transmitter in memory thereof.

3. The system of claim 2, wherein the server is further programmed to compare the location of the electronic authentication card to the location of the at least one transmitter.

4. The system of claim 3, wherein the server is further configured to authorize the purchase in response to determining that the location of the electronic authentication card is within a pre-designated area of a merchant after comparing the location of the electronic authentication card to the location of the at least one transmitter.

5. The system of claim 1, wherein the electronic authentication card is further configured to wirelessly communicate with a mobile device.

6. The system of claim 5, wherein the server is further configured to authorize the purchase in response to determining that the mobile device is within a predetermined distance of the electronic authentication card.

7. The system of claim 1, wherein the electronic authentication card is further programmed to receive timestamps from the at least one transceiver and to transmit the timestamps to the server, wherein the timestamps serve as an identifier for the at least one transceiver.

8. The system of claim 7, wherein the server is further configured to:
determine whether the timestamps identify the at least one transceiver is within a predetermined distance of the electronic authentication device;
authorize the purchase if the timestamps identify the at least one transceiver is within the predetermined distance of the electronic authentication device; and
reject the purchase if the timestamps identify the at least one transceiver is outside of the predetermined distance of the electronic authentication device.

9. The system of claim 1, wherein the electronic authentication card is further programmed to receive identifier information on the plurality of wireless signals from the at least one transceiver and to transmit the identifier information to the server, and wherein the identifier information is indicative of a location of the at least one transceiver.

10. The system of claim 1, wherein the server is programmed to store previously stored identifier information for the at least one transceiver.

11. The system of claim 10, wherein the server is further programmed to compare the received identifier information from the electronic authentication card to the previously stored identifier information.

12. The system of claim 10, wherein the server is further programmed to authorize the purchase for the use in response to received identifier information from the electronic authentication card matching the previously stored identifier information.

13. The system of claim 1, wherein the electronic authentication card is a credit card.

14. The system of claim 1, wherein the server is programmed to identify the location of the electronic authentication card independent of global positioning system (GPS) coordinates.

15. The system of claim 1, wherein the electronic authentication card is further configured to process the plurality of wireless signals to generate first information that is indicative of the location of the electronic authentication card based on a time of arrival of the plurality of wireless signals.

16. The system of claim 15, wherein the electronic authentication card is further configured to process the plurality of wireless signals to generate first information that is indicative of the location of the electronic authentication card based on a carrier phase difference between the plurality of wireless signals.

17. A system for performing chain of custody monitoring, the system comprising:
at least one transceiver for receiving a plurality of wireless signals from at least one transmitter; and
at least one processor for being coupled to the at least one transceiver and to an object, the at least one processor being programmed to:
process the plurality of wireless signals to generate first information indicative of a plurality of locations of the object,
wirelessly transmit the first information to a server; and
wirelessly receive a plurality of location coordinates from the server identifying the plurality of locations of the object based on the first information as the object travels from a starting point to an arrival point.

18. The system of claim 17, wherein the server is programmed to transmit second information indicative of a report corresponding a plurality of locations of the object as the object traverses terrestrially from the starting point to the arrival point.

20. The system of claim 17, wherein the server is further programmed to receive timestamps from the least one processor to provide a total time the object has been in transit from the starting point to the arrival point based on the timestamps.

21. The system of claim 17, wherein the server is further programmed to generate an alert indicative of the chain of custody being broken in the event: (i) the processor has failed to wirelessly transmit the first information to the server within a predetermined amount of time, (ii) one or more of the plurality of locations of the object is detected to be out of a predetermined area, (iii) an apparent speed of the object exceeds a predetermined speed of travel, or (iv) one or more of the plurality of locations of the object is determined to be inconsistent based on a plurality of first wireless signals transmitted from a plurality of access points.

22. The system of claim 17, wherein the at least one processor is further configured to process the plurality of wireless signals to generate first information that is indicative of the location of the object based on a time of arrival of the plurality of wireless signals.

23. The system of claim 17, wherein the at least one processor is further configured to process the plurality of wireless signals to generate first information that is indicative of the location of the object based on a carrier phase difference between the plurality of wireless signals.

24. A system for monitoring a transit of a parcel, the system comprising:
at least one transceiver for receiving a plurality of wireless signals from at least one transmitter; and
at least one processor for being coupled to the at least one transceiver and to the parcel, the at least one processor being programmed to:
process the plurality of wireless signals to generate first information indicative of a plurality of locations of the parcel,
transmit the first information to a server; and
receive a plurality of location coordinates from the server identifying the plurality of locations of the parcel based on the first information as the parcel travels from a starting point to an arrival point.

25. The system of claim 24, wherein the at least one processor is further configured to process the plurality of wireless signals to generate first information that is indicative of the location of the parcel based on a time of arrival of the plurality of wireless signals.

26. A shipping container comprising:
a parcel configured to store a good;
an array of antennas for wirelessly receiving a plurality of wireless signals; and
a location tag being including the array of antennas for attachment to the parcel, the location tag being programmed to:
process the plurality of wireless signals to generate first information indicative of a plurality of locations of the parcel during transit,
transmit the first information to a server; and
receive a plurality of location coordinates from the server identifying the plurality of locations of the parcel based on the first information as the parcel travels from a starting point to a destination point.

28. The shipping container of claim 26, wherein the parcel is non-reusable or a reusable container.

29. A system for providing a location of a vehicle to a user, the system comprising:
at least one transceiver programmed to receive a plurality of wireless signals from at least one transmitter; and
at least one processor for being coupled to the at least one transceiver and to the vehicle, the at least one processor being programmed to:
process the plurality of wireless signals to generate first information indicative of a location of the vehicle,
transmit the first information to a server; and
receive location coordinates from the server identifying the location of the vehicle.

30. The system of claim 29, wherein the server transmits the location of the vehicle to the user in response to the first information.

31. The system of claim 29, wherein the at least one transceiver is further programmed to receive timestamps from the at least one transmitter and the at least one processor is further programmed to transmit the timestamps to the server.

32. The system of claim 31, wherein the server is further programmed to determine an estimated time of arrival for the vehicle to rendezvous with the user in response to the timestamps.

33. The system of claim 29, wherein the at least one processor is further configured to process the plurality of wireless signals to generate first information that is indicative of the location of the vehicle based on a time of arrival of the plurality of wireless signals.

34. The system of claim 29, wherein the at least one processor is further configured to process the plurality of wireless signals to generate first information that is indicative of the location of the vehicle based on a carrier phase difference between the plurality of wireless signals.

35. The system of claim 29, wherein the server is further programmed to:
determine a location of a mobile device belonging to the user based on the location of the vehicle and on a known location of two or more wireless receivers that wirelessly communicate with the server and on a known location of the at least one transmitter.

36. The system of claim 35, wherein the server is further programmed to:
transmit the location of the mobile device belonging to the user to the vehicle; and
transmit the location of the vehicle to the mobile device of the user to establish a rendezvous with the vehicle.
